(19) United States
(12) Patent Application Publication
(10) Pub. No.: US 2012/0268765 A1
(43) Pub. Date: Oct. 25, 2012

(54) LAYOUT EVALUATING APPARATUS

(76) Inventor: Yasushi YAMADE, Yokohama (JP)

(21) Appl. No.: 13/448,954

(22) Filed: Apr. 17, 2012

(30) Foreign Application Priority Data
Apr. 19, 2011 (JP) 2011-93371

(51) Int. Cl. G06K 15/02

(52) U.S. Cl. 358/1.13; 358/1.15

(57) ABSTRACT

Disclosed is a layout evaluating apparatus including: a detecting unit to detect an action of a user who provides a print instruction to a shared device which is shared by a plurality of users and has a print function, the action being involved with the print instruction; a judging unit to judge importance of a print in the print instruction in accordance with the action of the user, which the detecting unit detects; and an evaluating unit to aggregate the importance of each print with respect to each user and to evaluate an installation place of the shared device in accordance with the aggregated importance of each print with respect to each user.

### BACKGROUND OF THE INVENTION

1. Field of the Invention

The present invention relates to a layout evaluating apparatus for evaluating the arrangement of a shared device which is shared by a plurality of users, such as a multi-function peripheral having a print function, a scan function and the like.

2. Description of Related Art

In case that a shared device which is shared by a plurality of users, such as a multi-function peripheral having a print function, a scan function and the like, a copying machine, a printer or the like, is installed in an office, the efficiency of the work is improved by selecting a suitable installation place of the shared device. Therefore, various types of technologies for evaluating the arrangement of the shared device or for calculating the recommended arrangement thereof are proposed.

For example, in an installation place determination device, after the seat position of each user and the candidates for installation place of the shared device are specified, each movement distance between the seat position of each user and each candidate for the installation place is calculated. Then, by multiplying each movement distance by the number of times of use of the shared device with respect to each user, the total movement distance of each candidate for the installation place is calculated. The candidate for the installation place, which has the shortest total movement distance, is determined as an installation place of the shared device (See Japanese Patent Application Publication No. 2004-302652).

In other technologies relating to the layout, there is a shipping warehouse layout design support method for automatically preparing a storage layout for the commercial products so as to dispose the commercial products having the high frequency of the dispatch from a warehouse near the entrance of the warehouse on the basis of a map of the warehouse and each frequency of dispatching the commercial products stored in the warehouse (See Japanese Patent Application Publication No. 2002-288248). Further, there is a technology for analyzing a work style in an office (such as, trading type, project type, concentrate type, or transaction type of work style) to determine the equipments which are necessary for the office. In this technology, it is judged whether the determined equipments can be installed in the office, and the layout of the office is carried out (See Japanese Patent Application Publication No. 2001-184375).

In various jobs, such as a print job, a scan job and the like which are executed by the shared device, such as a multi-function peripheral, there are urgent jobs and jobs which are not urgent. In the urgent jobs, because a user wants to promptly obtain a printed document or scan data which are produced by executing the jobs, it is preferable that the user's seat is near the multi-function peripheral. On the other hand, in the jobs which are not urgent, even if the user's seat is far from the multi-function peripheral, there are few problems. Therefore, in case that the arrangement of the shared device, such as a multi-function peripheral, is evaluated or proposed, it is preferable to consider the frequency of requesting high urgent jobs by each user.

However, in conventional technologies for proposing or evaluating the arrangement, the above point is not considered. For example, in the technology disclosed in Japanese Patent Application Publication No. 2004-302652, because any use of the shared device is treated at the same weighting regardless of the importance or the urgency of each use of the shard device, the arrangement of the shared device cannot be proposed so as to match the actual usage of the shared device by each user by considering the urgency of each job.

### SUMMARY

To achieve at least one of the abovementioned objects, a layout evaluating apparatus reflecting one aspect of the present invention comprises:

a detecting unit to detect an action of a user who provides a print instruction to a shared device which is shared by a plurality of users and has a print function, the action being involved with the print instruction;

a judging unit to judge importance of a print in the print instruction in accordance with the action of the user, which the detecting unit detects; and

an evaluating unit to aggregate the importance of each print with respect to each user and to evaluate an installation place of the shared device in accordance with the aggregated importance of each print with respect to each user.

Preferably, the detecting unit detects at least one of a time period which elapses since the user provides the print instruction until the user receives a printed document and a time period which elapses since the user receives the printed document until the user returns back to a seat of the user, as the action involved with the print instruction, and

the judging unit judges that the importance of the print is high as the detected time period becomes short.

Preferably, the detecting unit detects at least one of a route on which the user moves since the user provides the print instruction until the user receives a printed document and a route on which the user moves since the user receives the printed document until the user returns back to a seat of the user, as the action involved with the print instruction, and

the judging unit judges that the importance of the print is high as the detected route approximates a shortest route.

Preferably, the shared device further has an original reading function for reading an original,

the detecting unit detects at least one of an action of the user, which is involved with a starting operation for starting a reading job to read an original by using the shared device, and an action of the user, which is involved with a reception of a resultant caused by the reading job,

the judging unit judges importance of the reading job in accordance with the detected action of the user, and

the evaluating unit aggregates the importance of each reading job with respect to each user and evaluates the installation place of the shared device in accordance with the aggregated importance of each reading job with respect to each user and the aggregated importance of each print with respect to each user.

Preferably, the detecting unit detects a time period which elapses since the user carries out the starting operation until the user carries out an operation for a file of the resultant caused by the reading job, as the action involved with the reception of the resultant, and

the judging unit judges that the importance of the reading job is high as the detected time period becomes short.

Preferably, the detecting unit detects a time period which elapses since the user carries out the starting operation until the user returns back to a seat of the user, as the action involved with the reception of the resultant, and

the judging unit judges that the importance of the reading job is high as the detected time period becomes short.

Preferably, the detecting unit detects a time period which elapses since the user starts a movement from a seat of the user until the user carries out the starting operation, as the action involved with the starting operation, and

the judging unit judges that the importance of the reading job is high as the detected time period becomes short.

Preferably, the detecting unit detects a route on which the user moves since the user carries out the starting operation until the user returns back to a seat of the user, as the action involved with the reception of the resultant, and

the judging unit judges that the importance of the reading job is high as the detected route becomes short.

Preferably, the detecting unit detects a route on which the user moves since the user rises from a seat of the user until the user carries out the starting operation, as the action involved with the starting operation, and

the judging unit judges that the importance of the reading job is high as the detected route becomes short.

Preferably, the shared device further has a copy function for copying an original,

the evaluating unit aggregates the number of times of executing a copy job with respect to each user, and evaluates the installation place of the shared device by further considering the aggregated number of times of executing the copy job with respect to each user.

Preferably, the evaluating unit judges importance of each user in accordance with the aggregated importance of each print with respect to each user, and calculates a recommended ratio of a distance between each user and the shared device in accordance with the judged importance of each user.

Preferably, the layout evaluating apparatus further comprises:

an installation place determining unit to determine the installation place of the shared device in accordance with the recommended ratio; and

a display unit to display the determined installation place of the shared device.

Preferably, the evaluating unit calculates a weighted movement distance by multiplying the importance of each user by the distance between each user and the shared device, with respect to each user, and

the display unit displays the weighted movement distances of the plurality of users so as to compare the weighted movement distances.

Preferably, the display unit displays a recommended installation place of the shared device, in which a total of the weighted movement distances of the plurality of users is the smallest among a plurality of candidates for the recommended installation place.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is an explanatory view showing a multi-function peripheral system including a layout evaluating apparatus according to the embodiment;

FIG. 2 is a view showing an example of a layout of an office in which the multi-function peripheral system is adopted;

FIG. 3 is an explanatory view showing an action pattern of a user in case that the job is judged as the importance level 5;

FIG. 4 is an explanatory view showing an action pattern of a user in case that the job is judged as the importance level 4;

FIG. 5 is an explanatory view showing an action pattern of a user in case that the job is judged as the importance level 3;

FIG. 6 is an explanatory view showing an action pattern of a user in case that the job is judged as the importance level 2;

FIG. 7 is an explanatory view showing an action pattern of a user in case that the job is judged as the importance level 1;

FIG. 8 is a block diagram showing a schematic configuration of the multi-function peripheral;

FIG. 9 is a block diagram showing a schematic configuration of a user terminal;

FIG. 10 is a block diagram showing a schematic configuration of an information collecting terminal;

FIG. 11 is a view showing an example of the position detection of the user and the tracking method of the movement locus of the user by the position detection device;

FIG. 12 is a flowchart showing the position detection process carried out by the position detection device;

FIG. 13 is an explanatory view showing an example of the position detection information (movement locus registration table) accumulated in the information collecting terminal;

FIG. 14 is a flowchart showing a process of the document print instruction carried out by the user terminal;

FIG. 15 is an elevation view showing an example of the print window;

FIG. 16 is an elevation view showing an example of the printer property window;

FIG. 17 is a flowchart showing the operation carried out by the printer driver of the user terminal;

FIG. 18 is a flowchart showing the operation of the multi-function peripheral which receives a PC print job from the user terminal;

FIGS. 19A and 19B are a flowchart showing the operation of the multi-function peripheral after the user authentication;

FIG. 20 is an elevation view showing an example of a login window;

FIG. 21 is an elevation view showing an example of an operation selection window;

FIG. 22 is an elevation view showing an example of a box file print window;

FIG. 23 is a flowchart showing a procedure of user's operation in case that a Scan To Box job is inputted;

FIG. 24 is an elevation view showing an example of a destination box selection window;

FIG. 25 is a flowchart showing the operation of the multi-function peripheral which executes a Scan To Box job;

FIG. 26 is a flowchart showing the operation which a user carries out by using the user terminal when a file stored in the box is read out;

FIG. 27 is an elevation view showing an example of the box management page;

FIG. 28 is a flowchart showing the operation of the multi-function peripheral which receives the instruction for obtaining a file in the box;

FIG. 29 is a flowchart showing the operation of the multi-function peripheral which executes a copy job;

FIG. 30 is an elevation view showing an example of the copy setting window;

FIG. 31 is a flowchart showing the information collecting process which the information collecting terminal carries out;

FIG. 32 is an elevation view showing an example of the print job history table;

FIG. 33 is an elevation view showing an example of the scan job history table;

FIG. 34 is an elevation view showing an example of the copy job history table;

FIGS. 35A and 35B are a flowchart showing the aggregation and evaluation process which the information collecting terminal;

FIG. 36 is an explanatory view showing the first judgment condition table in which the judgment conditions for judging the importance of each print job are registered;

FIG. 37 is an explanatory view showing the second judgment condition table in which the judgment conditions for judging the importance of each scan job are registered;

FIG. 38A and FIG. 38B are views showing the examples of the aggregation results relating to the user A and the user B;

FIG. 39 is an explanatory view showing the movement loci of the user A in the respective print jobs so as to overlap them;

FIG. 40 is an explanatory view showing the movement loci of the user B in the respective print jobs so as to overlap them;

FIG. 41 is an explanatory view showing an example of each route of the user A and the user B in case that the importance of the user A is 2 and the importance of the user B is 1;

FIG. 42 is a flowchart showing the evaluation process for the installation place of the multi-function peripheral;

FIG. 43 is a layout map in case that the current installation place is displayed and the first candidate for the installation place and the second candidate for the installation place are extracted; and

FIG. 44 is a view showing the calculation table of the total weighted movement distance in case of the current installation place, the calculation table of the total weighted movement distance in case of the first candidate for the installation place and the calculation table of the total weighted movement distance in case of the second candidate for the installation place.

### DETAILED DESCRIPTION OF PREFERRED EMBODIMENT

Hereinafter, a preferred embodiment of the present invention will be explained with reference to the accompanying drawings.

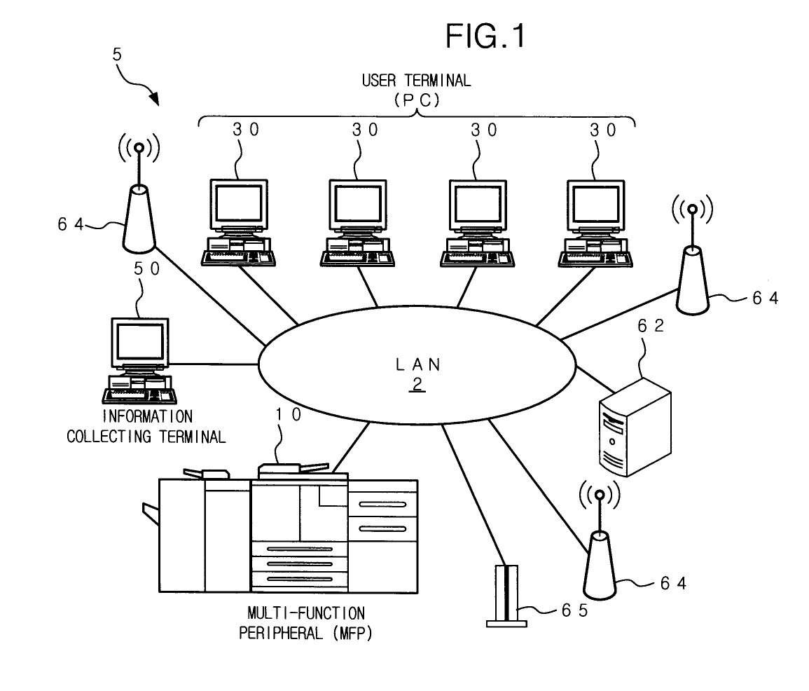

FIG. 1 shows the configuration of a multi-function peripheral system 5 including the layout evaluating apparatus according to one embodiment of the present invention. The multi-function peripheral system 5 comprises a multi-function peripheral 10 (also referred to as “MFP”) as a shared device which is shared by a plurality of users, a plurality of user terminals 30, an information collecting terminal 50 as a layout evaluating apparatus, an authorization server 62 which is served for the user authorization, a plurality of (in this embodiment, at least three) detectors 64 for detecting the route of the user from the signals which a portable terminal of the user outputs, and a position detection device 65 for detecting the position of each portable terminal from the detection result of the detectors 64, which are connected with a network 2, such as LAN (Local Area Network) which is provided in an office or the like.

The multi-function peripheral 10 is an image forming device having the function to execute various types of jobs, such as a copy job for printing out an image on recording paper by reading an original optically, a scan job for storing an image data obtained by reading the original as a file or for transmitting it to an external terminal, a PC print job for printing out the corresponding image on recording paper based on the print data received from the user terminal 30, a facsimile transmitting/receiving job and the like. The scan job includes a Scan To Box for storing a file of the image data in a store area referred to as a box in the multi-function peripheral 10, a Scan To Email for transmitting the file by attaching it to an electronic mail, and the like.

The user terminal 30 has a function to transmit a PC print job to the multi-function peripheral 10, a function to access a file which is stored in the box by the Scan To Box job, via the network 2, and the like.

The information collecting terminal 50 has a function to evaluate the arrangement of the multi-function peripheral 10. Specifically, the information collecting terminal 50 judges the importance (urgency) of each job which the user inputs to the multi-function peripheral 10, in accordance with, for example, the time period which elapses since the user carries out the input operation of the job until the user receives the resultant caused by the job, to aggregate the importance of each job with respect to each user. Then, in accordance with the aggregation result, the information collecting terminal 50 calculates the importance of each user (the degree of the importance of each user, which relates to the utilization of the multi-function peripheral 10). The information collecting terminal 50 proposes the suitable installation place of the multi-function peripheral 10 or evaluates the installation place of the multi-function peripheral 10 in accordance with the importance of each user.

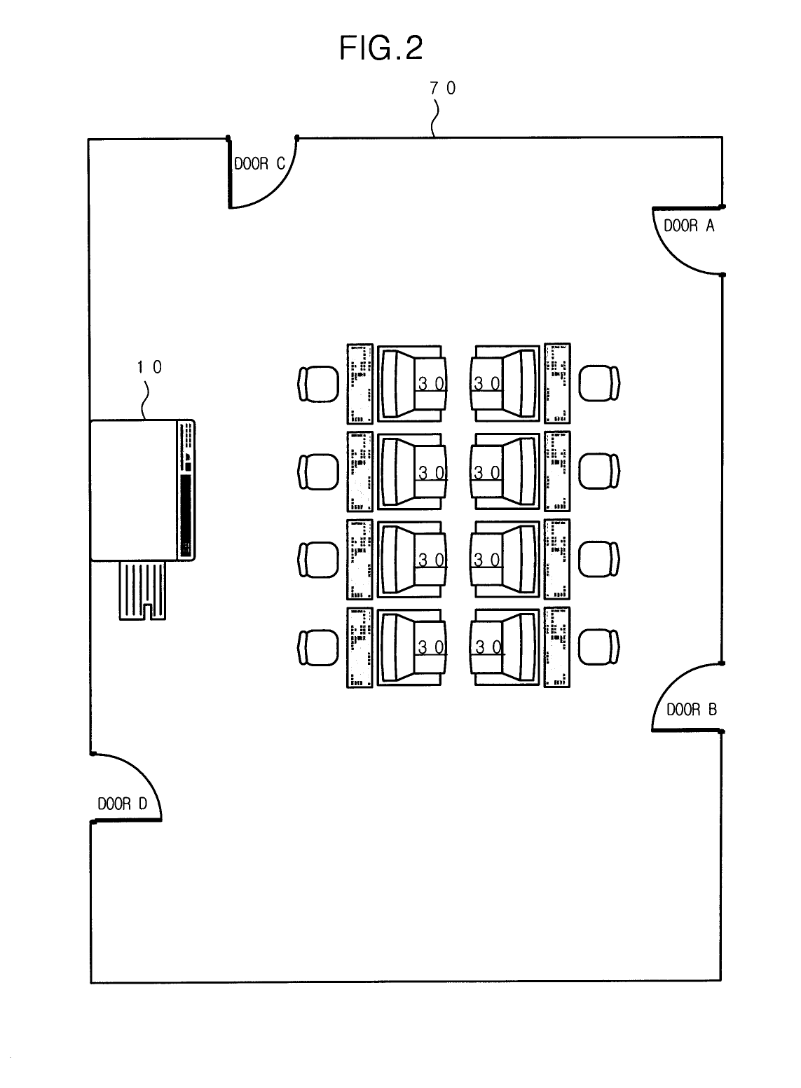

FIG. 2 shows an example of a layout of an office in which the multi-function peripheral system 5 is adopted. In the center of a room 70, desks and chairs of users are arranged in two rows facing each other. On the desk of each user, the user terminal 30 is provided. In the room 70, there are a plurality of entrances (door A, door B, door C and door D). The multi-function peripheral 10 is installed at the predetermined place along one wall of the room 70. The multi-function peripheral 10 is shared by a plurality of users having the seats in the room 70.

The importance of the job will be explained. The importance (urgency) of the job is judged on the basis of the action of the user who inputs the job. The action is involved with the input of the job or the receipt of the resultant caused by the job. That is, the importance of the job is judged on the basis of the factors, for example, depending on whether the user starts to move to the multi-function peripheral 10 from the user's seat in order to receive the resultant caused by the job as soon as the user inputs the job, depending on whether the user moves directly to the multi-function peripheral 10 from the user's seat without detouring, depending on whether the user moves directly back to the user's seat after the user directly operates the multi-function peripheral 10 or receives the printed document, and the like.

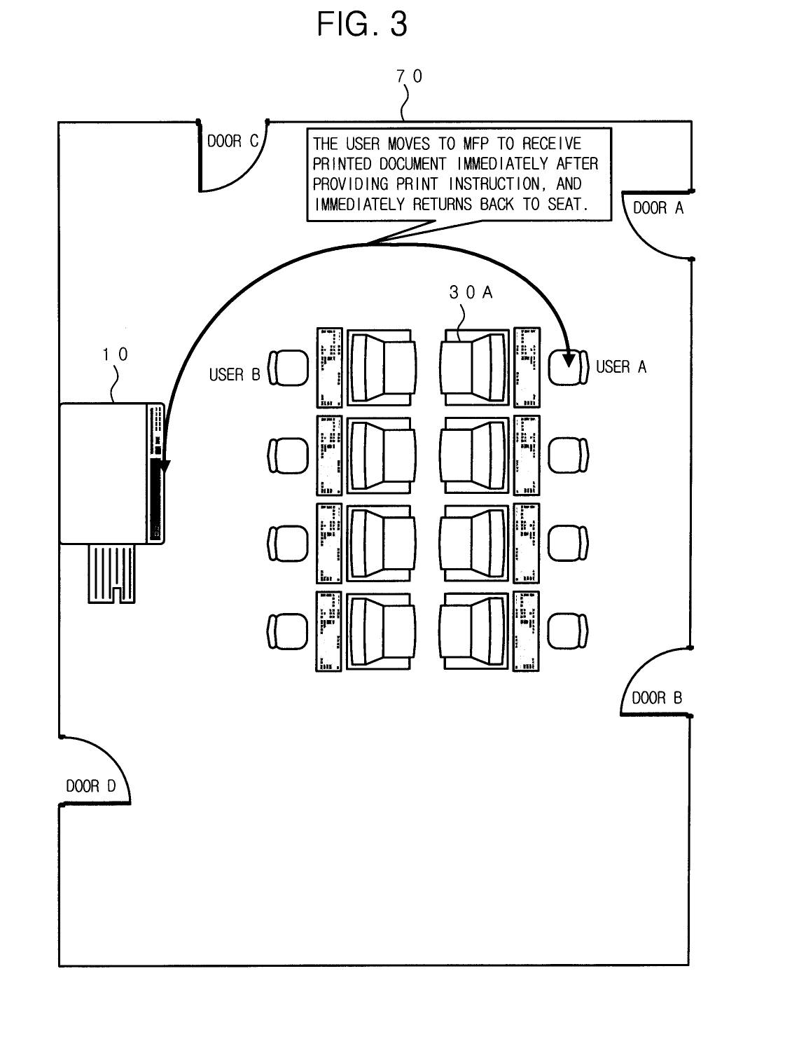

FIG. 3 shows the action pattern of the user in case that the job is judged as the importance level 5. In this embodiment, the importance of the job is classified in five levels (importance levels 1 to 5) and the importance level 5 is the highest importance. In the following action pattern, the job is judged as the job having the highest urgency and importance (the importance level 5). The user A provides the print instruction to the multi-function peripheral 10 from the user terminal 30A which is provided on the user A's seat (transmits a PC print job to the multi-function peripheral 10), and rises from the seat and moves directly to the multi-function peripheral 10 (without detouring) immediately after transmitting the print job. After the user A receives the printed document at the multi-function peripheral 10, the user A immediately moves back to the user A's seat.

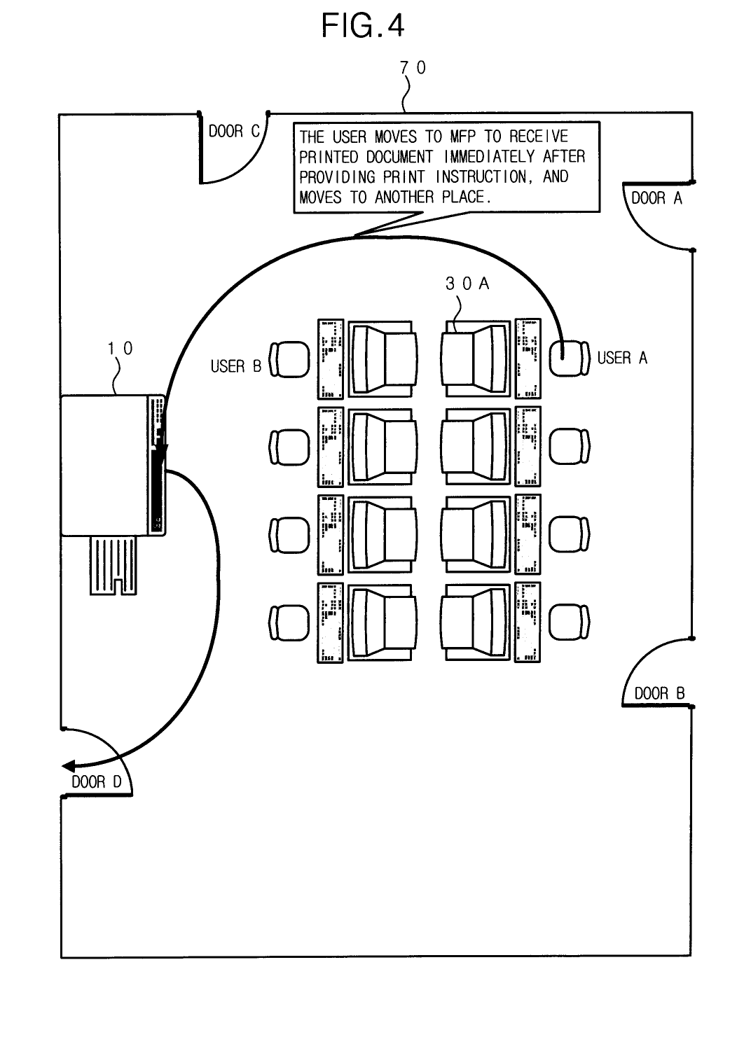

FIG. 4 shows the action pattern of the user in case that the job is judged as the importance level 4. In the following action pattern, the job is judged as the importance level 4. The user A provides the print instruction to the multi-function peripheral 10 from the user terminal 30A which is provided on the user A's seat, and rises from the seat and moves directly to the multi-function peripheral 10 (without detouring) immediately after transmitting the print job. After the user A receives the printed document at the multi-function peripheral 10, the user A moves to another place (for example, a conference room).

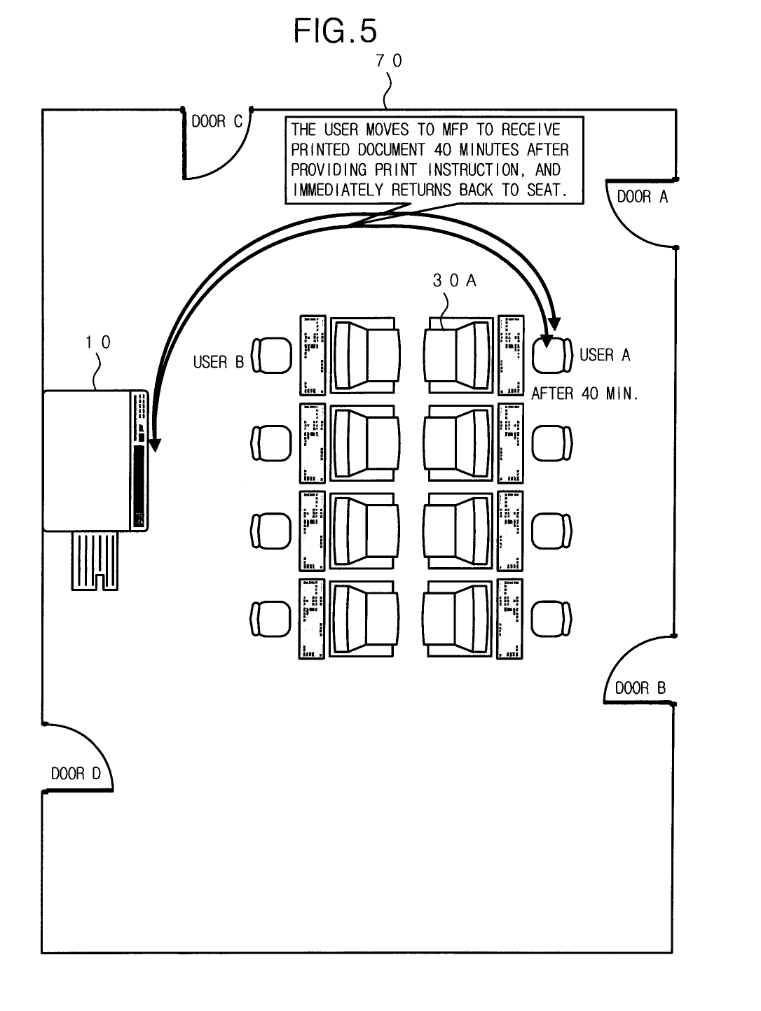

FIG. 5 shows the action pattern of the user in case that the job is judged as the importance level 3. In the following action pattern, the job is judged as the importance level 3. The user A provides the print instruction to the multi-function peripheral 10 from the user terminal 30A which is provided on the user A's seat, and rises from the seat and moves directly to the multi-function peripheral 10 (without detouring) forty minutes after transmitting the print job. After the user A receives the printed document at the multi-function peripheral 10, the user A immediately moves back to the user A's seat.

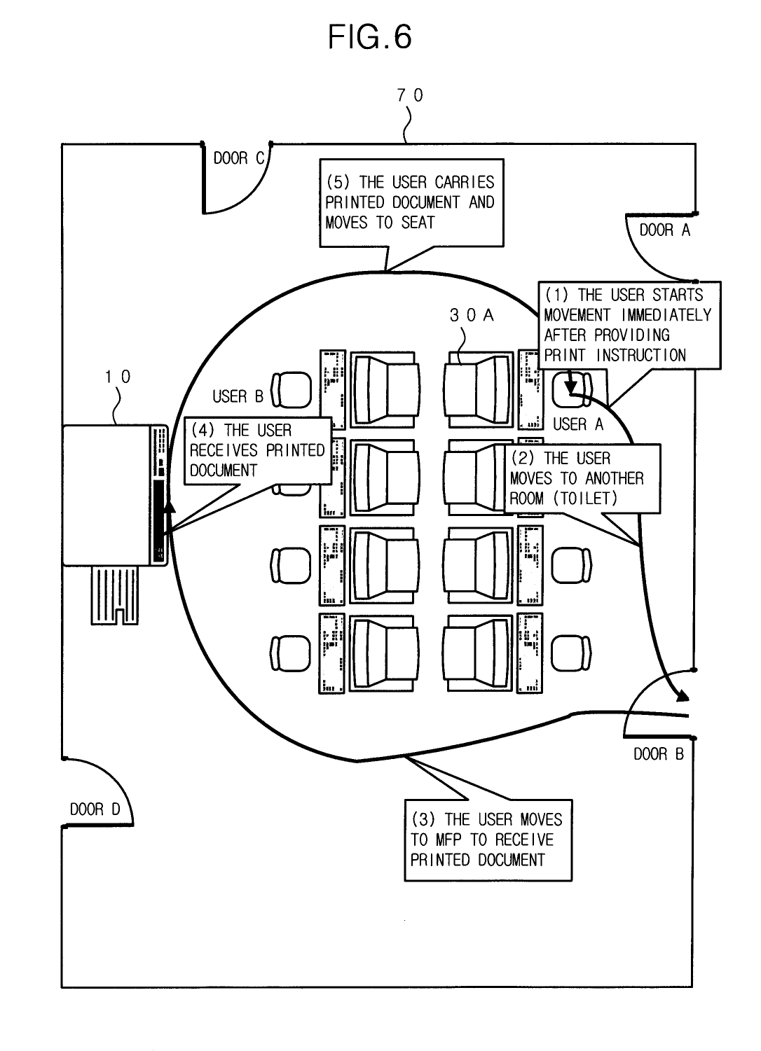

FIG. 6 shows the action pattern of the user in case that the job is judged as the importance level 2. In the following action pattern, the job is judged as the importance level 2. The user A provides the print instruction to the multi-function peripheral 10 from the user terminal 30A which is provided on the user A's seat, and rises from the seat and moves to another room (for example, a toilet) immediately after transmitting the print job. After the user A moves to the multi-function peripheral 10 from another room and receives the printed document at the multi-function peripheral 10, the user A immediately moves back to the user A's seat.

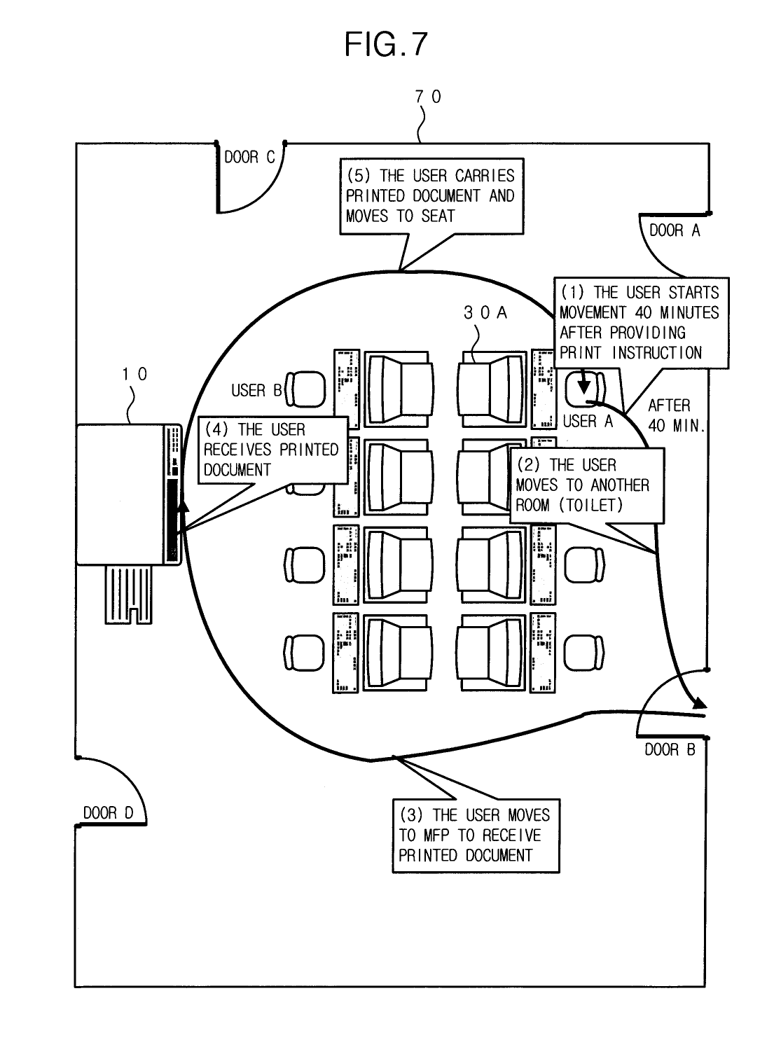

FIG. 7 shows the action pattern of the user in case that the job is judged as the importance level 1. In the following action pattern, the job is judged as the importance level 1. The user A provides the print instruction to the multi-function peripheral 10 from the user terminal 30A which is provided on the user A's seat, and rises from the seat and moves to another room (for example, a toilet) forty minutes after transmitting the print job. After the user A moves to the multi-function peripheral 10 from another room and receives the printed document at the multi-function peripheral 10, the user A immediately moves back to the user A's seat.

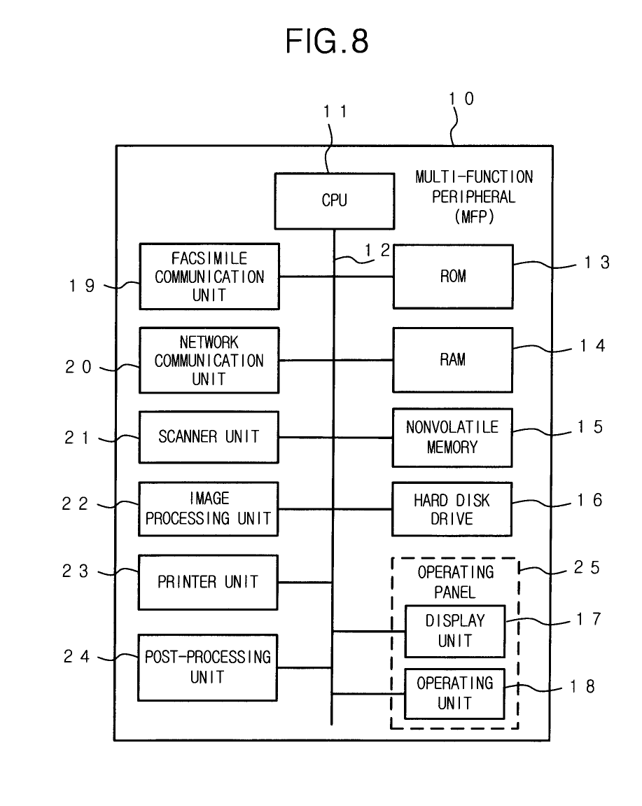

FIG. 8 is a block diagram showing the schematic configuration of the multi-function peripheral 10. The multi-function peripheral 10 comprises a CPU (Central Processing Unit) 11 for overall controlling the operation of the multi-function peripheral 10, a ROM (Read Only Memory) 13, a RAM (Random Access Memory) 14, a nonvolatile memory 15, a hard disk drive 16, a display unit 17, an operating unit 18, a facsimile communication unit 19, a network communication unit 20, a scanner unit 21, an image processing unit 22, a printer unit 23, and a post-processing unit 24 which are connected with the CPU 11 via a bus 12.

By the CPU 11, a middleware, application programs and the like are executed on an OS program as a base. In the ROM 13, various types of programs are stored. By executing the processes in accordance with these programs, the CPU 11 realizes the functions of the multi-function peripheral 10, such as the execution of jobs. The RAM 14 is used as a work memory for temporarily storing various data when the CPU 11 executes the programs and as an image memory for storing image data. Other necessary programs are executed by loading them to the RAM 14 from the hard disk drive 16.

The nonvolatile memory 15 is a rewritable memory (flash memory) in which the contents are stored even if the multi-function peripheral 10 is turned off. In the nonvolatile memory 15, the unique information (IP (Internet Protocol) address or the like) of the multi-function peripheral 10, various types of setting information and the like are stored. The hard disk drive 16 is a large-capacity nonvolatile memory device, and is used in order to store programs and other data, such as print data, image data, job history data and the like.

An operating panel 25 of the multi-function peripheral 10 comprises the display unit 17 and the operating unit 18. The display unit 17 is configured by a liquid crystal display or the like, and displays various screens, such as an initial screen, an operation screen, a setting screen and the like. The operating unit 18 receives various operations from the user, such as the input and setting of a job, and the like. The operating unit 18 comprises a touch panel which is provided on the screen of the display unit 17. The touch panel detects a coordinate position in which the user pushes down. Further, the operating unit 18 comprises a numerical keypad, an alphabetical keypad, a start key and the like.

The facsimile communication unit 19 transmits image data to an external device having a facsimile function and receives image data from the external device via a public line. The network communication unit 20 communicates with the user terminal 30, the information collecting terminal 50, the authorization server 62 and the like via the network 2.

The scanner unit 21 obtains image data by optically reading an image of an original. For example, the scanner unit 21 comprises a light source for irradiating the original with light, a line image sensor for reading the original line by line in the width direction of the original by receiving the reflected light from the original, a moving unit for sequentially moving the reading position line by line in the longitudinal direction of the original, an optical system having lenses, mirrors and the like for guiding the reflected light from the original to the line image sensor and focusing the reflected light on the line image sensor, a converting unit for converting an analog image signal outputted from the line image sensor into digital image data, and the like.

The image processing unit 22 carries out various image processings, such as the rasterization processing for converting print data into image data, image compensation, rotation, enlargement/reduction, compression/decompression of image data, and the like.

The printer unit 23 forms an image based on image data, on recording paper by the electrophotographic process, and outputs the recording paper. For example, the printer unit 23 is configured as the so-called laser printer comprising a conveying device for the recording paper, a photoconductive drum, a charging device, an LD (Laser Diode) of which the lighting is controlled in accordance with the input image data, a scanning unit for scanning the photoconductive drum by the laser light outputted from the LD, a developing device, a transfer and separation device, a cleaning device and a fixing device. Another type of printer, such as an LED (Light Emitting Diode) printer which irradiates the photoconductive drum with an LED head instead of laser light, may be used.

The post-processing unit 24 carries out post-processings (finishing processes), such as staple, punch, fold, booklet, insert sheet and the like, for the recoding paper on which the image is printed from the printer unit 23.

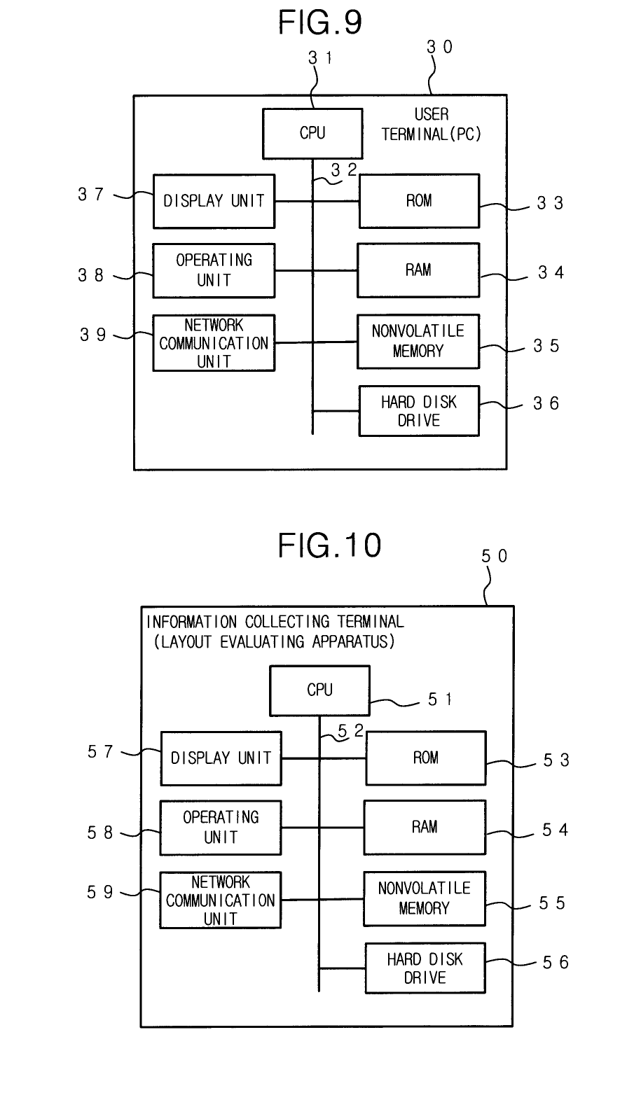

FIG. 9 shows the schematic configuration of the user terminal 30. The user terminal 30 is a personal computer (PC) or the like, in which an OS program, a driver program for the multi-function peripheral 10, application programs for preparing or editing document data or image data, a browsing program for accessing and displaying Web (World Wide Web) pages and the like are installed. Various requests to the multi-function peripheral 10, such as the input of PC print jobs, are carried out by the above driver program.

The user terminal 30 is configured so as to connect a CPU 31 with a ROM 33, a RAM 34, a nonvolatile memory 35, a hard disk drive 36, a display unit 37, an operating unit 38, a network communication unit 39 and the like via a bus 32.

The CPU 31 controls the operation of the user terminal 30 in accordance with the program stored in the ROM 33. Further, the CPU 31 executes various processes in accordance with the programs stored in the hard disk drive 36. In the ROM 33, a start-up program, fixed data and the like are stored. In the RAM 34, the programs read out from the hard disk drive 36 are stored. Further, the RAM 34 is used as a work memory for temporarily storing various data when the CPU 31 executes the programs.

In the nonvolatile memory 35, system information of the user terminal 30 (such as the terminal information (terminal ID (Identification)), IP (Internet Protocol) address or the like), user information (user ID), various types of setting information and the like are stored. The hard disk drive 36 is a large-capacity nonvolatile memory device. In the hard disk drive 36, an OS program, a driver program for the multi-function peripheral 10, various types of application programs, files, data and the like are stored.

The display unit 37 is configured by a display device, such as a liquid crystal display or the like. The operating unit 38 is configured by an operating input device, such as a keyboard, a mouse or the like.

The network communication unit 39 communicates with the multi-function peripheral 10, the information collecting terminal 50 and the like via the network 2, to transmit and receive various data.

FIG. 10 shows the schematic configuration of the information collecting terminal 50. The information collecting terminal 50 is a personal computer (PC) or the like, in which the predetermined programs are installed, like the user terminal 30. In detail, the information collecting terminal 50 is configured so as to connect a CPU 51 with a ROM 53, a RAM 54, a nonvolatile memory 55, a hard disk drive 56, a display unit 57, an operating unit 58, a network communication unit 59 and the like via a bus 52.

The CPU 51 controls the operation of the information collecting terminal 50 in accordance with the program stored in the ROM 53. In particular, the CPU 51 has a function as a detecting unit to detect the action of the user, which is involved with the print instruction or the like, a judging unit to judge the importance of the print job or the like in accordance with the detected action of the user, and an evaluating unit to aggregate the importance of each print job or the like with respect to each user and to evaluate the installation place of the multi-function peripheral 10 in accordance with the aggregation result. Further, the CPU 51 executes various processes in accordance with the programs stored in the hard disk drive 56. In the ROM 53, a start-up program, fixed data and the like are stored. In the RAM 54, the programs read out from the hard disk drive 56 are stored. Further, the RAM 54 is used as a work memory for temporarily storing various data when the CPU 51 executes the programs.

In the nonvolatile memory 55, system information of the information collecting terminal 50 (such as the terminal information (terminal ID), IP address or the like), various types of setting information and the like are stored. The hard disk drive 56 is a large-capacity nonvolatile memory device. In the hard disk drive 56, an OS program, various types of application programs, files, data for realizing the function as the layout evaluating apparatus, and the like are stored.

The display unit 57 is configured by a display device, such as a liquid crystal display or the like. The operating unit 58 is configured by an operating input device, such as a keyboard, a mouse or the like.

The network communication unit 59 communicates with the multi-function peripheral 10, the user terminals 30 and the like via the network 2, to transmit and receive various data.

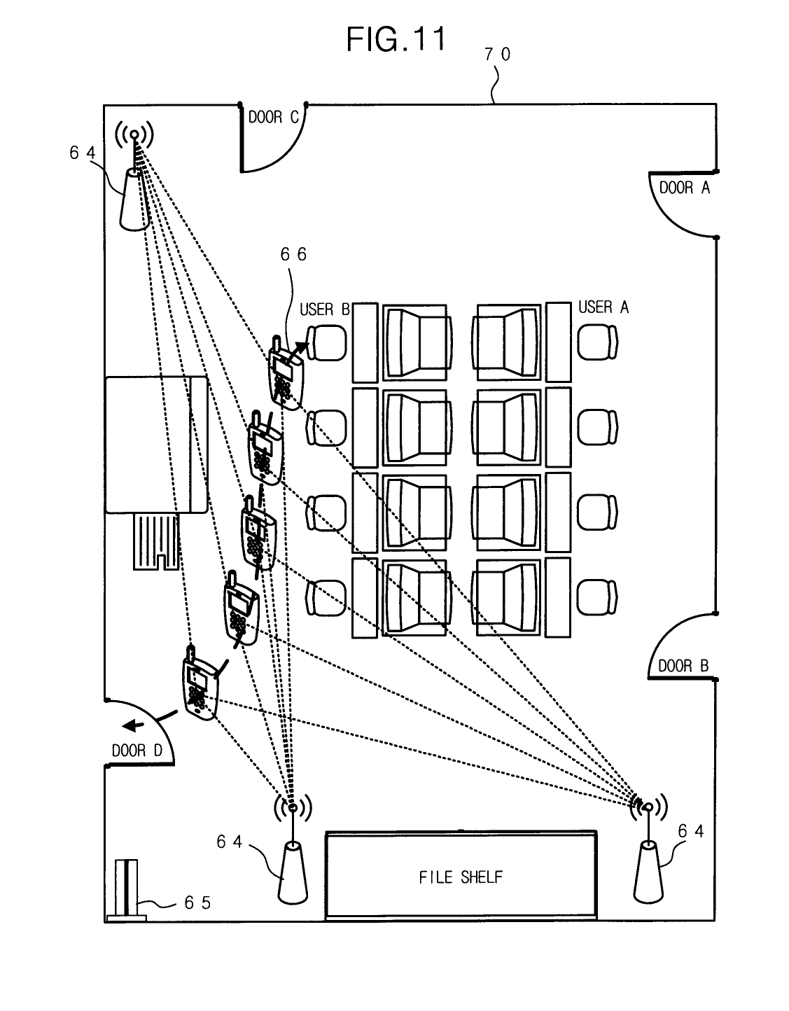

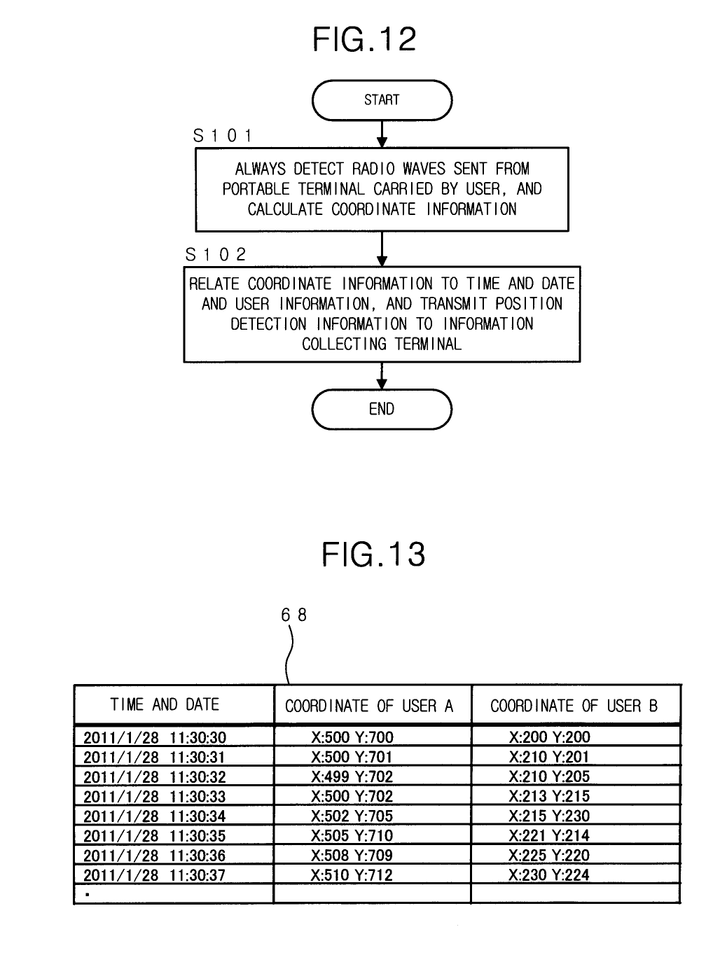

FIG. 11 shows an example of the position detection of the user and the tracking method of the movement locus of the user by the position detection device 65. FIG. 12 shows the flowchart of the position detection process carried out by the position detection device 65. Each user carries a portable terminal 66 having a function of sending signals. At least at three points in the room 70, the detectors 64 for detecting the signals sent from the portable terminals 66 are provided so as to be apart from each other.

Each detector 64 always detects radio waves sent from the portable terminal 66 carried by the user. The position detection device 65 periodically (for example, per 1 second) calculates the position (coordinate information) of each portable terminal 66 on the basis of the detection result of each detector 64 (Step S101 in FIG. 12). For example, the position detection device 65 estimates each distance between each detector 64 and the portable terminal 66 from the intensity of the signal received by each detector 64, and calculates the position (coordinate information) of each portable terminal 66 by the triangulation technology. Then, the position detection device 65 transmits the position detection information in which the coordinate information of the detected position is related to the time and date of the detection of the portable terminal 66 and the identification (user information) of the portable terminal 66, to the information collecting terminal 50 (Step S102). The information collecting terminal 50 accumulates the above position detection information.

FIG. 13 shows an example of the position detection information (the movement locus registration table 68) accumulated in the information collecting terminal 50. In this embodiment, the positions (the coordinate information) of the user A and those of the user B are registered in time series and with respect to each user. By connecting the positions of each user in time series, the movement locus of the user can be recognized. The original point of the coordinate can be optionally set. For example, one corner of the room 70 is set to the original point.

Next, the procedure and the process for printing out an image by transmitting a PC print job to the multi-function peripheral 10 from the user terminal 30 in the multi-function peripheral system 5 will be explained.

In this embodiment, when the multi-function peripheral 10 receives a PC print job, the multi-function peripheral 10 does not immediately print an image and temporarily stores the PC print job in the box. Then, the user who transmits the PC print job, moves to the multi-function peripheral 10 and carries out the user authorization. When the user inputs the print instruction for the image data (file) stored in the box to the operating panel 25 of the multi-function peripheral 10, the multi-function peripheral 10 executes the print out.

Therefore, in case of carrying out the PC print, the action of the user is as follows. The user transmits the PC print job to the multi-function peripheral 10 from the user terminal 30 which is provided on the user's seat. Then, the user moves to the multi-function peripheral 10 to which the PC print job is transmitted, and carries out the user authorization at the multi-function peripheral 10. The user instructs the multi-function peripheral 10 to execute the print out by carrying out the print operation for the file stored in the box. The user receives the printed document and moves to the user's destination (the user's seat or another room, such as a conference room).

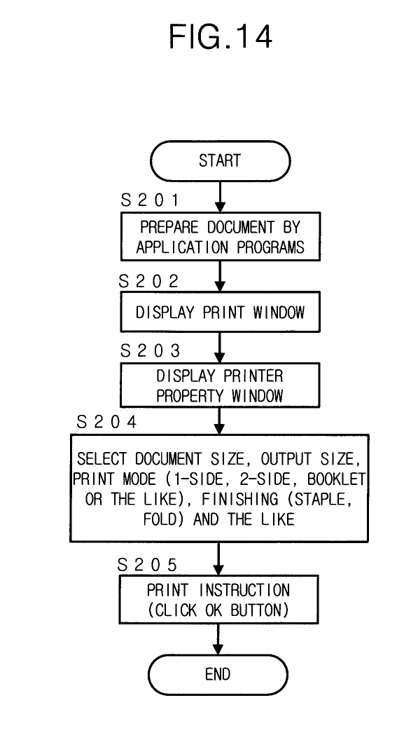

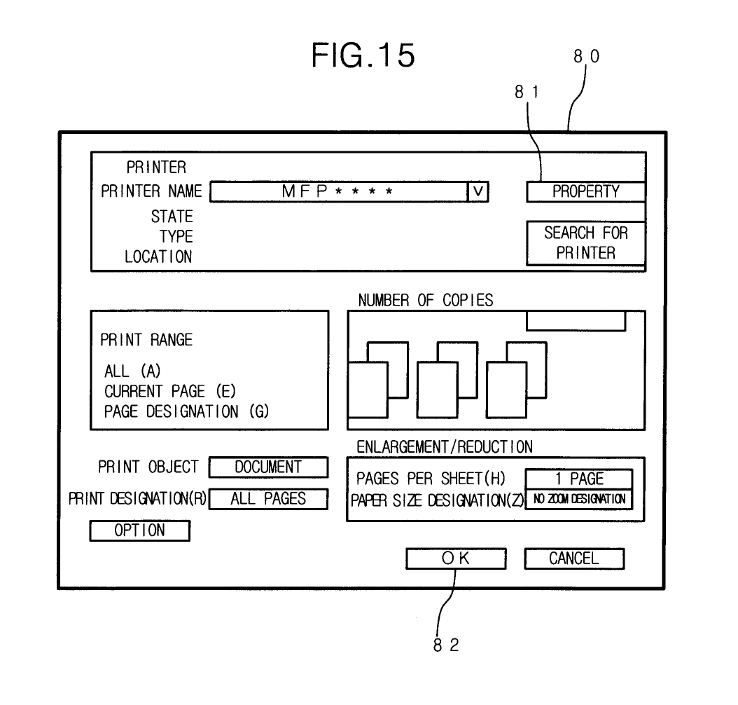

FIG. 14 shows the process of the document print instruction carried out by the user terminal 30. In the user terminal 30, the document is prepared by the application program on the basis of the input operation of the user (Step S201). When the user terminal 30 receives the operation for opening the print menu of the application program from the user, the user terminal 30 displays the print window 80 (See FIG. 15) on the display unit 37 (Step S202).

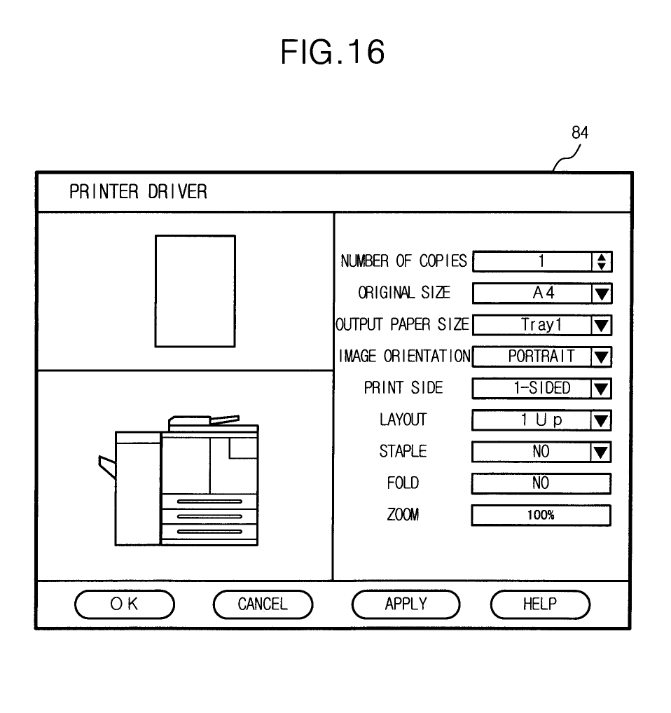

When the property button 81 of the print window 80 is clicked, the user terminal 30 displays the printer property window 84 (See FIG. 16) on the display unit 37 (Step S203). The user terminal 30 receives the setting for the post-processing (finishing), such as staple, fold and the like via the printer property window 84 (Step S204) and returns to the print window 80.

Then, the user terminal 30 receives the print instruction by clicking the OK button 82 of the print window 80 (Step S205). When the OK button 82 is clicked, the printer driver transmits the PC print job to the multi-function peripheral 10.

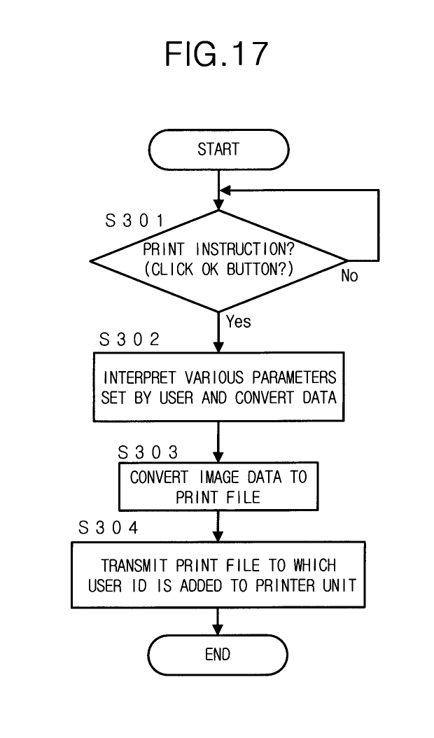

FIG. 17 shows the operation carried out by the printer driver of the user terminal 30. When the user terminal 30 receives the print instruction (the click of the OK button 82) via the print window 80 of FIG. 15 (Step S301; Yes), the printer driver prepares a setting file by carrying out the interpretation of various parameters and the data conversion in accordance with the settings received via the printer window 80 and the printer property window 84 (Step S302). Further, the printer driver carries out the conversion to the print file of the document image data (Step S303). The printer driver prepares the PC print job including the prepared setting file, the print file, the terminal information (terminal ID, user information) and the like, to transmit the job to the designated multi-function peripheral 10 (Step S304).

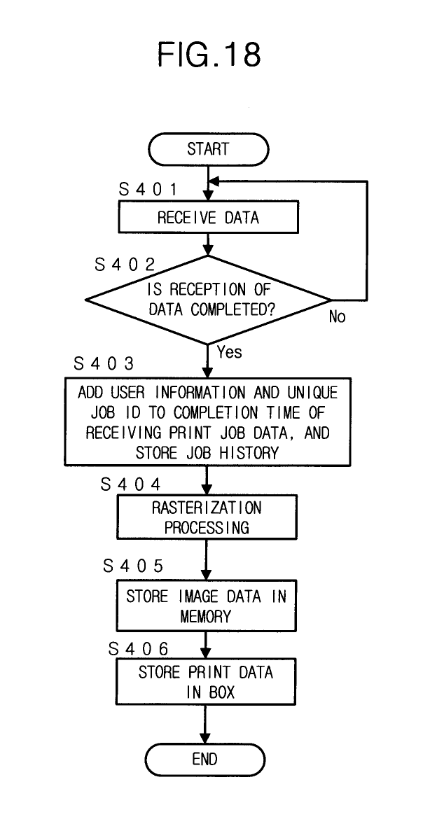

FIG. 18 shows the operation of the multi-function peripheral 10 which receives the PC print job from the user terminal 30. The multi-function peripheral 10 receives the PC print job (print job data) from the printer driver of the user terminal 30 (Step S401). When the reception of the job is completed (Step S402; Yes), the multi-function peripheral 10 prepares the job history in which the completion time of receiving the job (time and date of the job reception completion) is related to the user information which is included in this PC print job and the job ID which is assigned to this job by the user terminal 30, and stores the prepared job history (Step S403).

Then, the multi-function peripheral 10 carries out the rasterization processing for the print file of the received PC print job (Step S404), and stores the image data obtained by converting the print file to a bit map file, in the RAM 14 (Step S405). Further, the multi-function peripheral 10 stores the image data as a file in the box of the user indicated by the user information of the received PC print job (Step S406). Then, the process is ended.

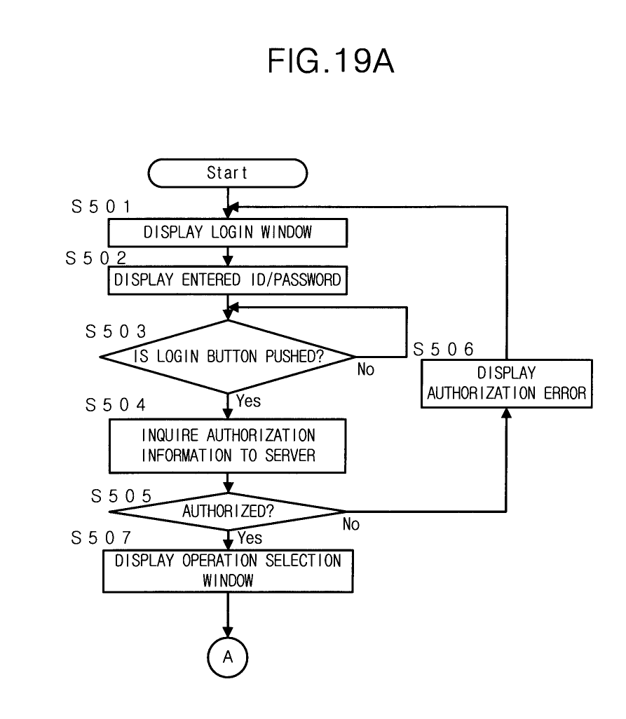

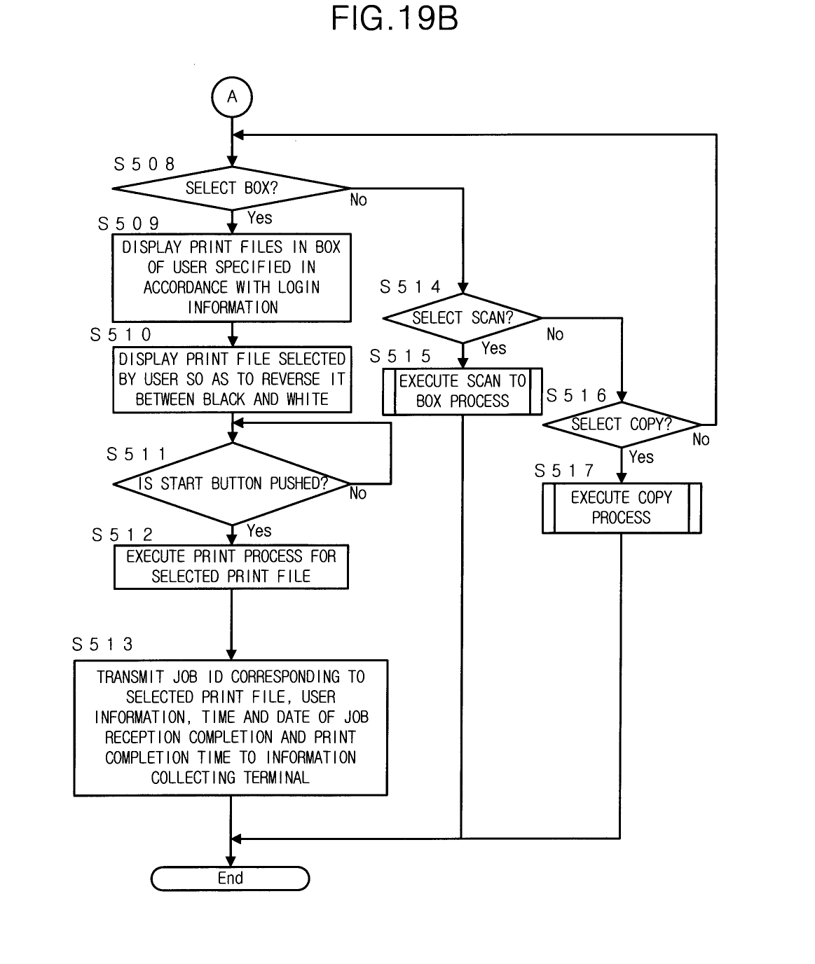

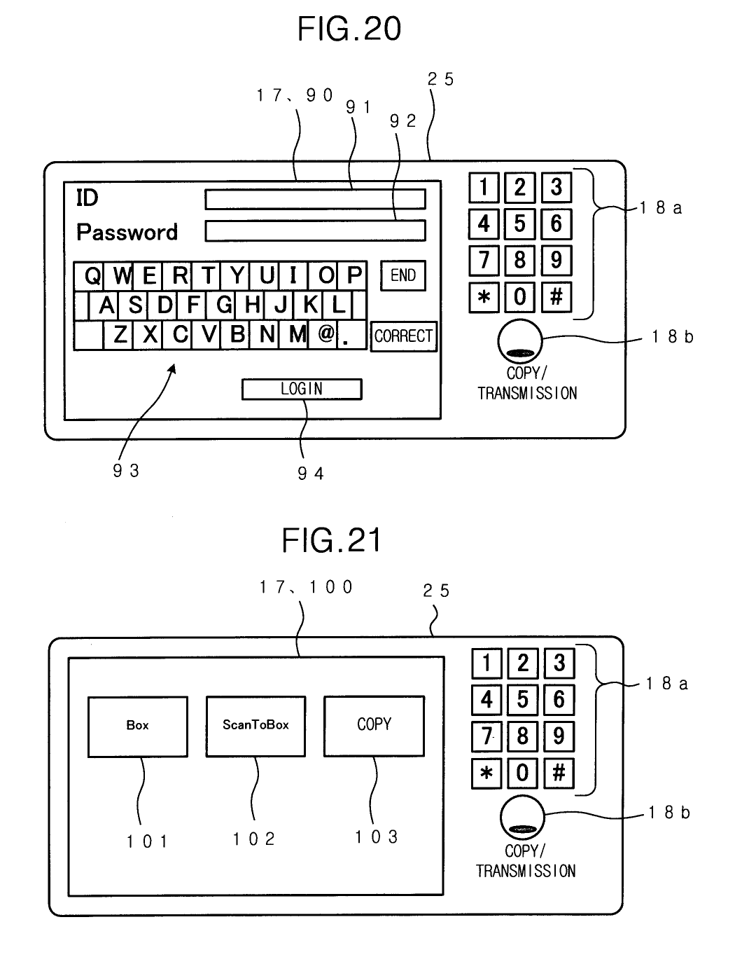

FIGS. 19A and 19B are the flowchart showing the operation of the multi-function peripheral 10 after the user authentication. The multi-function peripheral 10 displays the login window 90 shown in FIG. 20 on the display unit 17 of the operating panel 25 (Step S501). In the login window 90, a user ID enter box 91, a password enter box 92, a soft keyboard 93, a login button 94 and the like are displayed. In the operating panel 25, as hard keys, a numerical keypad 18a and a start key 18b are provided.

When the user enters the user ID and the password of the user in the user ID enter box 91 and the password enter box 92 respectively by using the soft keyboard 93 and the like, the multi-function peripheral 10 displays the entered contents in the corresponding enter boxes 91 and 92 (Step S502). When the multi-function peripheral 10 receives the pushing operation for the login button 94 (Step S503; Yes), the multi-function peripheral 10 transmits the entered user ID and the entered password to the authorization server 62 and inquires whether the user is authorized (Step S504).

In case that the multi-function peripheral 10 receives the response that the authorization is failed, from the authorization server 62 (Step S505; No), the multi-function peripheral 10 displays the authorization error (Step S506). Then, the process returns to Step S501.

In case that the multi-function peripheral 10 receives the response that the authorization is successful (Step S505; Yes), the multi-function peripheral 10 displays the operation selection window 100 shown in FIG. 21 on the display unit 17 (Step S507). In the operation selection window 100, as buttons for selecting the function to be executed, a Box button 101, a Scan To Box button 102 and a copy button 103 are displayed.

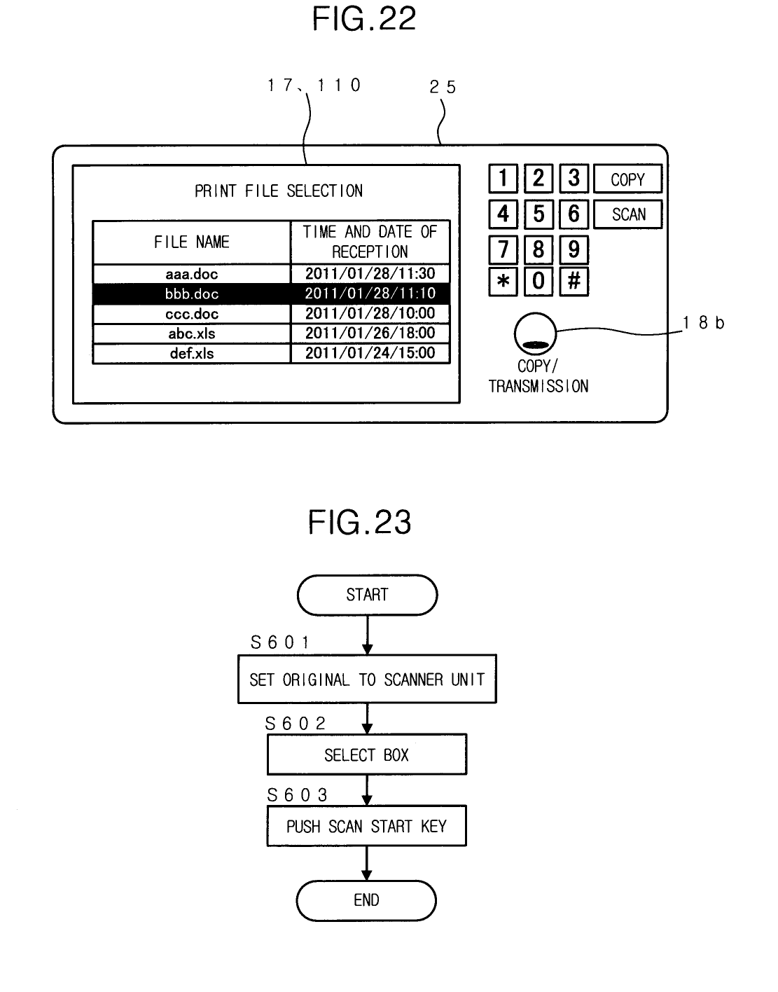

When the multi-function peripheral 10 receives the pushing operation for the Box button 101 (Step S508; Yes), the multi-function peripheral 10 specifies the user in accordance with the login information and displays the list of the files (print jobs) stored in the specified user's box in the box file print window 110 shown in FIG. 22 (Step S509). In the box file print window 110, the file name of each file and the time and date of the reception of the PC print job relating to each file are displayed as a list. The user can select the file to be printed by pushing the portion in which the file name of this file is displayed. When the operation for selecting the file is received, the CPU 11 of the multi-function peripheral 10 instructs the display unit 17 to display the portion in which the selected file is displayed, so as to reverse the portion between black and white (Step S510).

When the multi-function peripheral 10 receives the pushing operation for the start key 18b in the state that the file to be printed is selected (Step S511; Yes), the multi-function peripheral 10 executes the print process for the selected file (Step S512). Specifically, the multi-function peripheral 10 reads out the file to be printed from the box and prints out the corresponding image on recording paper by the printer unit 23. When the post-processing (staple, fold or the like) is set, the post-processing unit 24 carries out the post-processing for the recording paper on which the image is printed, and outputs the recording paper for which the post-processing is carried out.

When the print of the file is completed, the CPU 11 transmits the job information in which the time and date of the completion of the job print (the print completion time) is related to the job ID of the PC print job corresponding to the above file, the user information and the time and date of the job reception completion (which are stored in Step S403 of FIG. 18), to the information collecting terminal 50 (Step S513). Then, the process is ended.

When the Scan To Box button 102 is pushed in the operation selection window 100 (Step S514; Yes), the multi-function peripheral 10 executes the Scan To Box process (Step S515). When the copy button 103 is pushed (Step S516; Yes), the multi-function peripheral 10 executes the copy process (Step S517).

Next, the procedure and the process for executing the Scan To Box job will be explained.

In case of executing the Scan To Box job, the action of the user is as follows. The user carries an original and moves to the multi-function peripheral 10 from the user's seat. The user carries out the user authorization at the multi-function peripheral 10 and instructs the multi-function peripheral 10 to read the original and to store the file thereof in the box of the multi-function peripheral 10. Then, for example, the user returns back to the user's seat and opens a browsing program of the user terminal 30 to obtain the file by transmitting the instruction for obtaining the file stored in the box, to the multi-function peripheral 10.

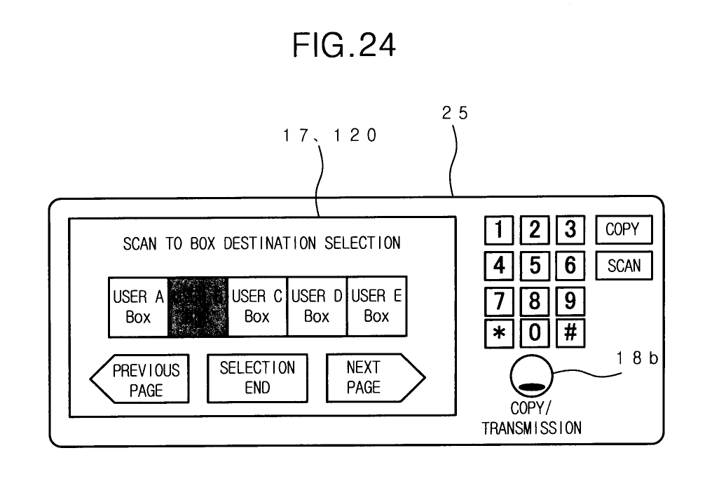

FIG. 23 shows the procedure of user's operation in case that the Scan To Box job is inputted. After the user logs in the multi-function peripheral 10, the user sets the original to the automatic document feeder of the scanner unit 21 (Step S601). The user operates the Scan To Box button 102 in the operation selection window 100 (FIG. 21). When this operation is received, the multi-function peripheral 10 instructs the display unit 17 to display the destination box selection window 120 shown in FIG. 24. In the destination box selection window 120, the user selects the box in which the image data obtained by reading the original is stored (Step S602), and pushes the start key 18b (Step S603).

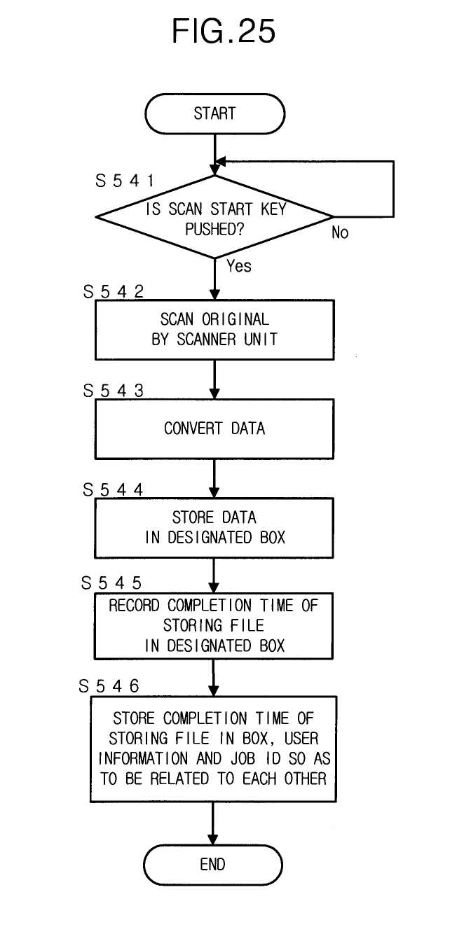

FIG. 25 is the flowchart showing the operation of the multi-function peripheral 10 which executes the Scan To Box job (the operation corresponding to Step S515 of FIG. 19B). When the pushing operation for the start key 18b is received in the state that the Scan To Box job is selected (Step S541; Yes), the scanner unit 21 reads (scans) the original (Step S542). The multi-function peripheral 10 converts the image data obtained by reading the original, into the file having the predetermined format (Step S543), and stores the file in the designated box (Step S544). Further, the multi-function peripheral 10 records the completion time of storing the file (time and date of the reading completion) (Step S545), and stores the recorded completion time, the user information of the user who inputs the Scan To Box job and the job ID of the Scan To Box job so as to be related to each other (Step S546). Then, the process is ended.

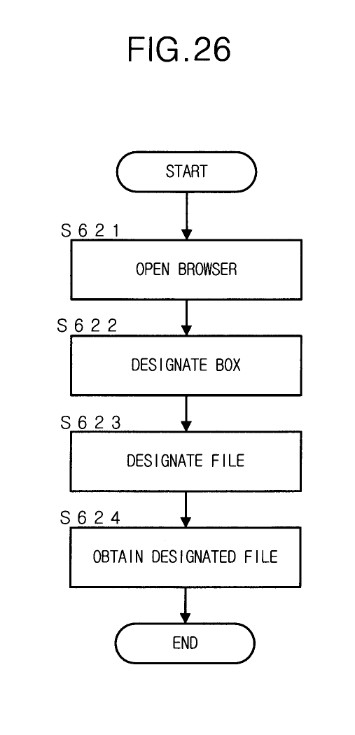

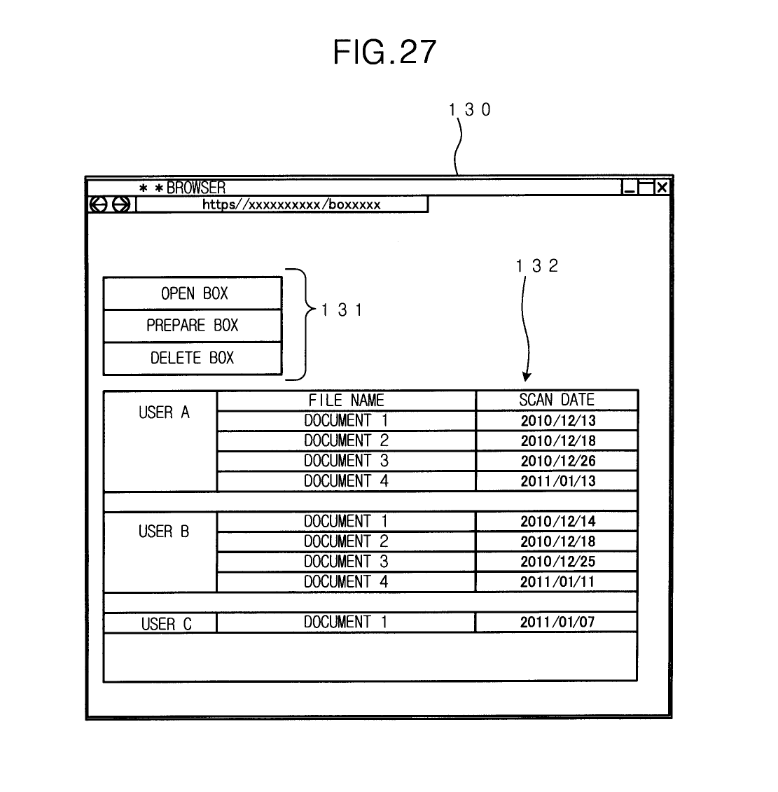

FIG. 26 shows the flowchart of the operation which the user carries out by using the user terminal 30 when the file stored in the box is read out. For example, the user opens the browsing program of the user terminal 30 (Step S621), and accesses the Web page (the box management page 130 shown in FIG. 27) for receiving various operations for the box in the multi-function peripheral 10. For example, the user opens this Web page by inputting the IP address of the designated multi-function peripheral 10.

In the box management page 130 of FIG. 27, the function buttons 131 for selecting the type of operation (open, prepare or delete) for the box, the file list 132 which indicates the files stored in the box of each user and the scanning time and date of the file, and the like are displayed.

The user designates the box and the file from the file list 132 (Steps S622 and S623) and instructs the user terminal 30 to obtain the designated file by pushing a button which is not shown (Step S624).

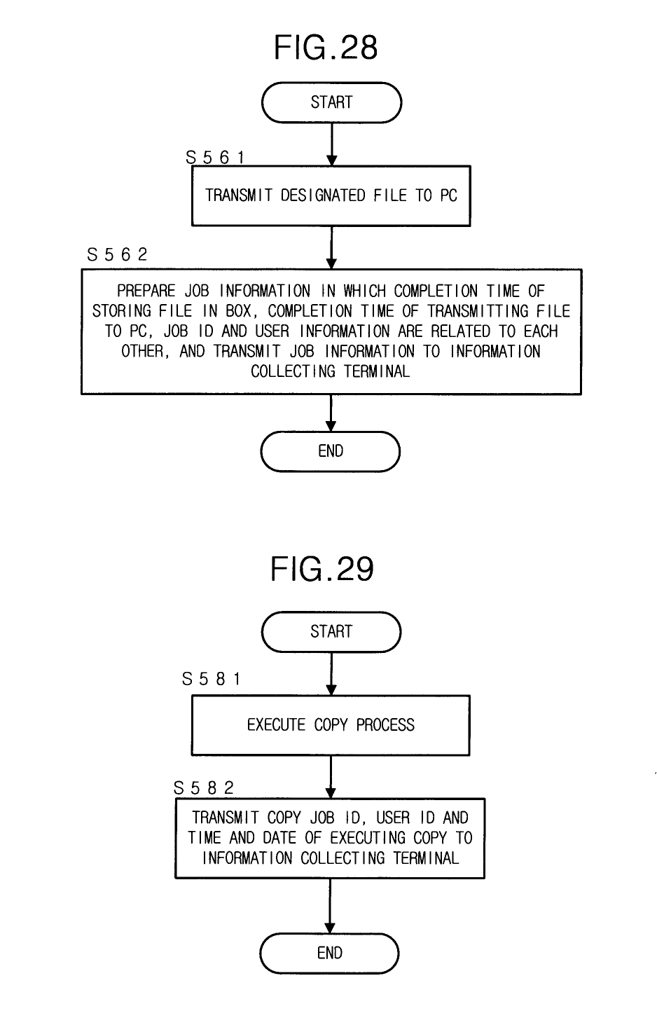

FIG. 28 shows the operation of the multi-function peripheral 10 which receives the instruction for obtaining the file in the box. When the multi-function peripheral 10 receives the instruction for obtaining the file from the user terminal (PC) 30, the CPU 11 transmits the designated file to the user terminal 30 which is the sender of the above instruction (Step S561). Further, the CPU 11 prepares the job information in which the time and date of the completion of transmitting the file to the user terminal 30 is related to the file storing time (time and date of the reading completion), the user information and the job ID which are stored in Step S546 of FIG. 25 when the file is stored in the box, and transmits the job information to the information collecting terminal 50 (Step S562). Then, the process is ended.

Next, the procedure and the process for executing a copy job will be explained.

In case of executing a copy job, the action of the user is as follows. The user carries an original and moves to the multi-function peripheral 10 from the user's seat. The user carries out the user authorization at the multi-function peripheral 10 and instructs the multi-function peripheral 10 to copy the original by reading it. Then, the user carries the original and the copied document and moves to the user's destination (the user's seat or another room, such as a conference room).

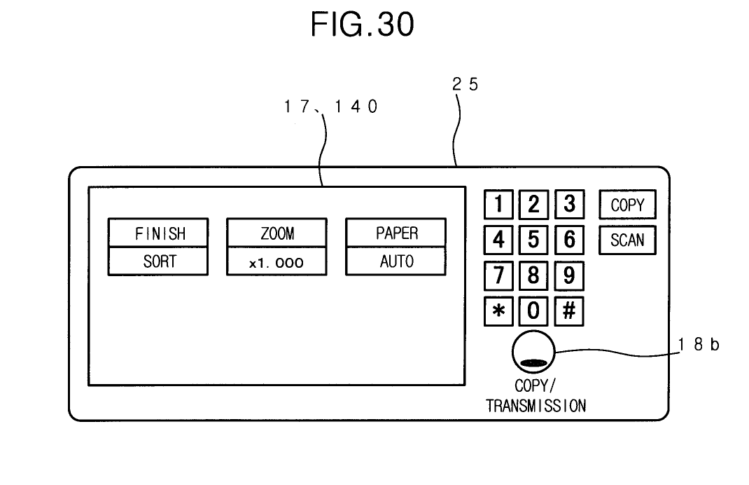

FIG. 29 shows the operation of the multi-function peripheral 10 which executes the copy job. After the user logs in the multi-function peripheral 10, the user sets the original to the automatic document feeder of the scanner unit 21. The user selects the copy button 103 in the operation selection window 100 (FIG. 21) and carries out various settings of the copy via the copy setting window 140 shown in FIG. 30. Then, when the start key 18b is pushed, the multi-function peripheral 10 executes the copy process (Step S581). The CPU 11 prepares the job information in which the job ID of the copy job, the user information (user ID) of the user who is logged in, the time and date of executing the copy are related to each other, and transmits the job information to the information collecting terminal 50 (Step S582). Then, the process is ended.

Next, the operation of the information collecting terminal 50 will be explained.

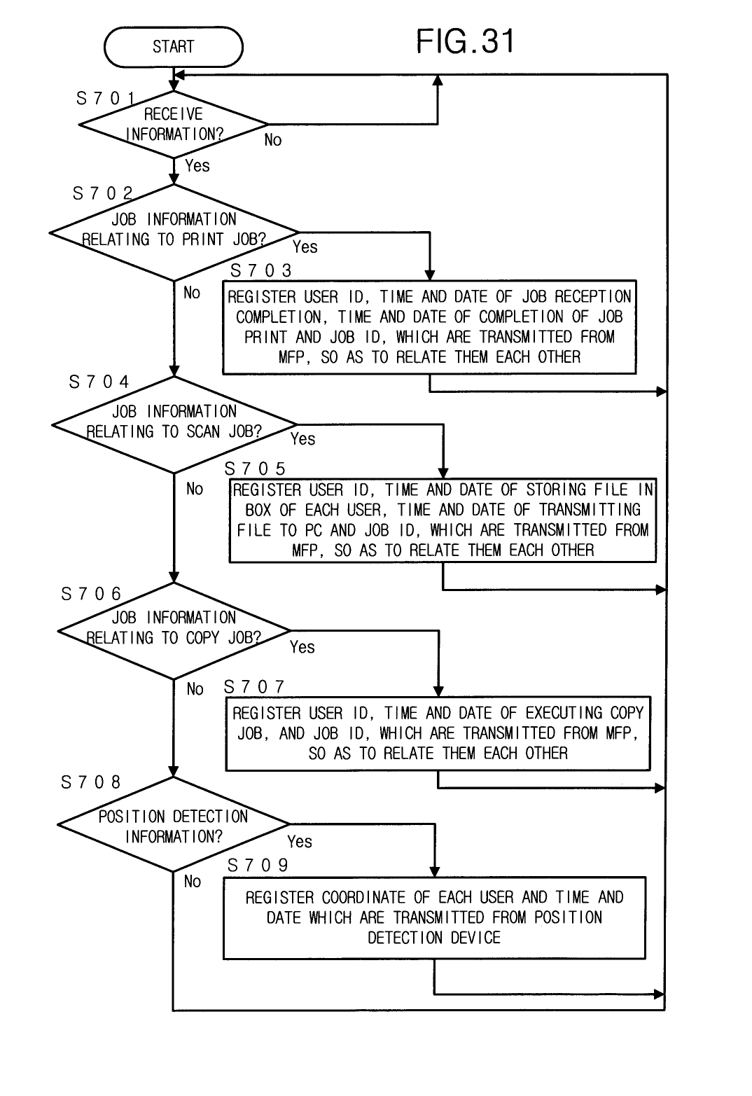

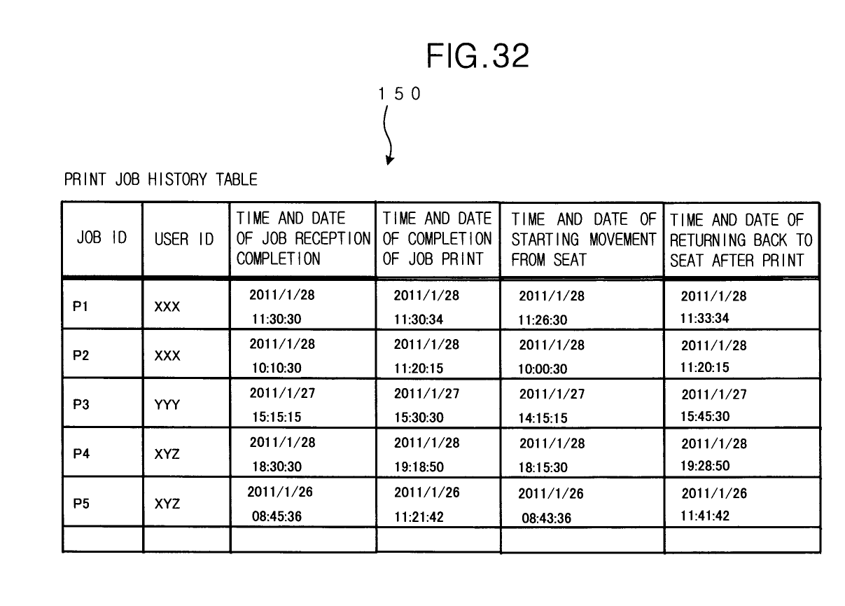

FIG. 31 shows the flowchart of the information collecting process which the information collecting terminal 50 carries out. When the information collecting terminal 50 receives any information (Step S701; Yes), the CPU 51 determines the type of the received information. In case that the received information is job information relating to a print job (Step S702; Yes), the CPU 51 relates the job ID of the received print job, the user information (user ID), the time and date of the job reception completion and the time and date of the completion of the job print to each other. The CPU 51 registers the above information to the print job history table 150 (See FIG. 32) (Step S703). The process returns to Step S701 and the information collecting terminal 50 waits to receive the next information.

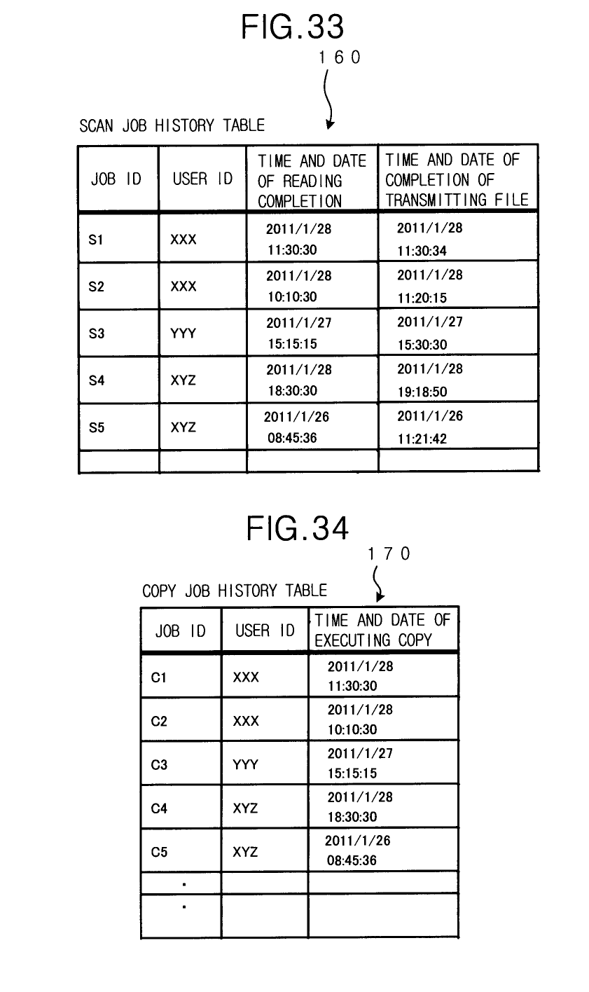

In case that the received information is job information relating to the Scan To Box job (Step S704; Yes), the CPU 51 relates the job ID of the received Scan To Box job, the user information (user ID), the time and date of the completion of transmitting the file and the time and date of the reading completion (time and date of storing the file in the box) to each other. The CPU 51 registers the above information to the scan job history table 160 (See FIG. 33) (Step S705). The process returns to Step S701 and the information collecting terminal 50 waits to receive the next information.

In case that the received information is job information relating to the copy job (Step S706; Yes), the CPU 51 relates the job ID of the received copy job, the user information (user ID), the time and date of executing the copy to each other. The CPU 51 registers the above information to the copy job history table 170 (See FIG. 34) (Step S707). The process returns to Step S701 and the information collecting terminal 50 waits to receive the next information.

In case that the received information is the position detection information transmitted from the information detection device 65 (Step S708; Yes), the CPU 51 registers the received position detection information to the movement locus registration table 68 shown in FIG. 13 (Step S709). The process returns to Step S701 and the information collecting terminal 50 waits to receive the next information.

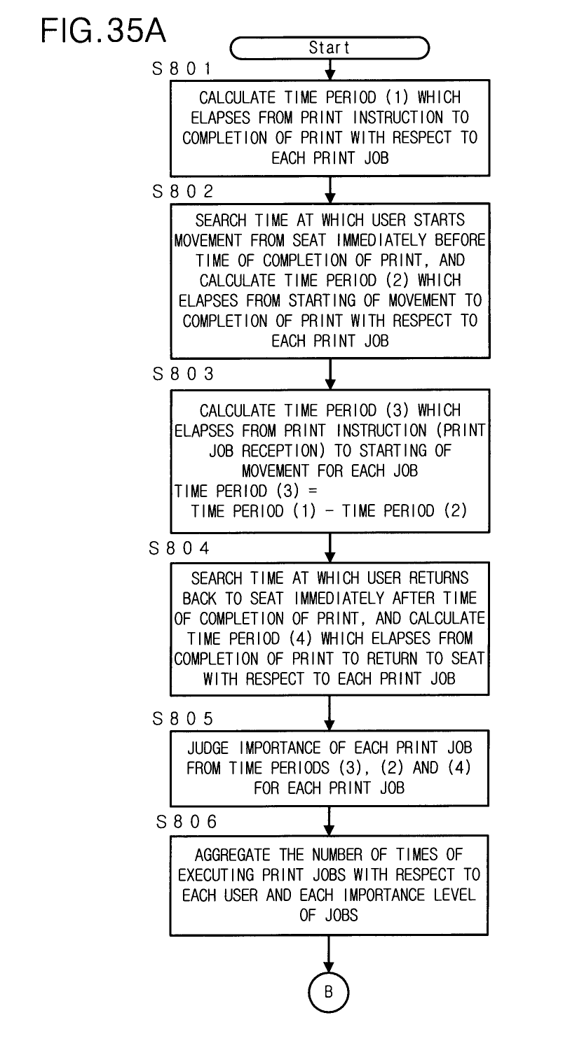

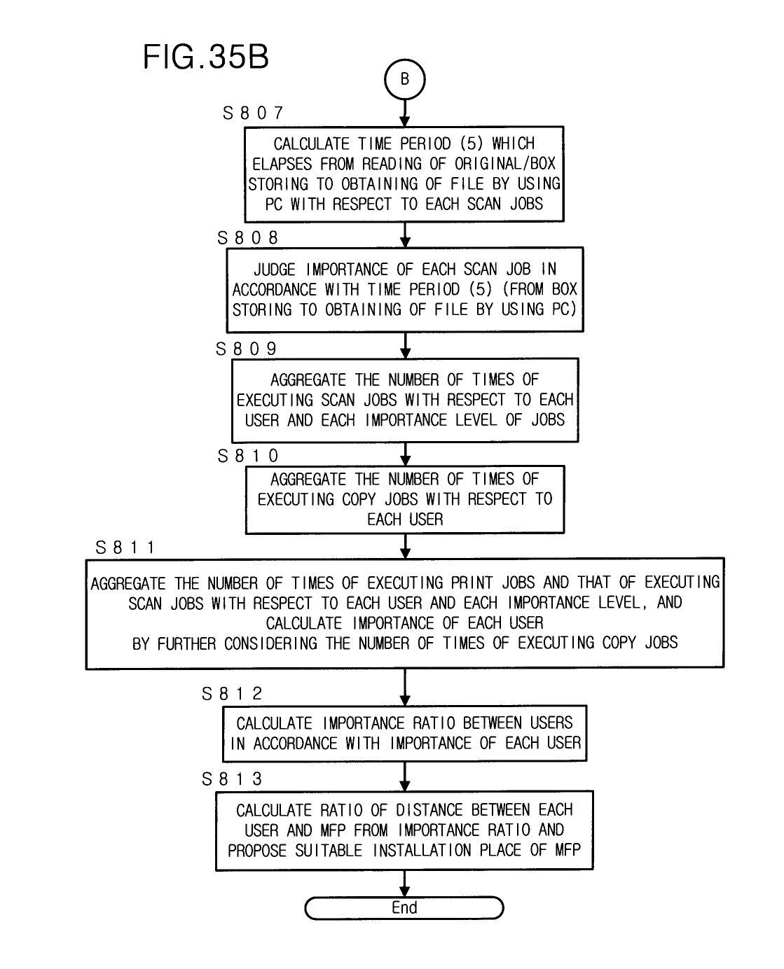

FIGS. 35A and 35B show the calculation and evaluation process which the information collecting terminal carries out. The CPU 51 of the information collecting terminal 50 calculates the time period (1) which elapses from the date and time of transmitting the print instruction (the time and date of the job reception completion) to the completion of the print (the time and date of the completion of the job print) with respect to each print job registered in the print job history table 150 (FIG. 32) (Step S801). In case that the aggregation period is set, only the jobs having the time and date of executing the job within the aggregation period are aggregated and evaluated.

With respect to each print job, the CPU 51 searches the time at which the user relating to the print job starts the movement from the user's seat immediately before the time of the completion of the print (the time and date of the completion of the job print), from the movement locus registration table 68 (FIG. 13). For example, in case that the user A provides the print instruction relating to a certain job, the CPU 51 searches the movement situation of the user A, which is caused immediately before the time and date of the completion of the job print, from the movement locus registration table 68 to specify the time at which the user A starts the movement from the user's seat. Then, the CPU 51 calculates the time period (2) which elapses from the starting of the movement to the completion of the print (the time and date of the completion of the job print) (Step S802). The time period (2) is the index for judging that the user immediately moves to the multi-function peripheral 10 from the user's seat or that the user detours to the multi-function peripheral 10.

With respect to each print job, the CPU 51 calculates the time period (3) which elapses from the time and date of transmitting the print instruction (the time and date of the job reception completion) to the starting of the movement. The time period (3) is calculated by subtracting the time period (2) for each job from the time period (1) for each job (Step S803). The time period (3) is the index for judging whether the user starts the movement immediately after providing the print instruction.

Further, with respect to each print job, the CPU 51 searches the time at which the user returns back to the user's seat immediately after the time of the completion of the print (the time and date of the completion of the job print) from the movement locus registration table 68. For example, in case that the user A provides the print instruction relating to a certain job, the CPU 51 searches the movement situation of the user A, which is caused immediately after the time and date of the completion of the job print relating to the above job from the movement locus registration table 68 to specify the time at which the user A returns back to the user's seat. Then, the CPU 51 calculates the time period (4) which elapses from the time and date of the completion of the print to the return to the user's seat (Step S804). The time period (4) is the index for judging whether the user directly (rapidly) returns back to the user's seat after the user receives the printed document.

Next, the CPU 51 judges the importance of each print job from the above time periods (2), (3) and (4) calculated for each print job (Step S805).

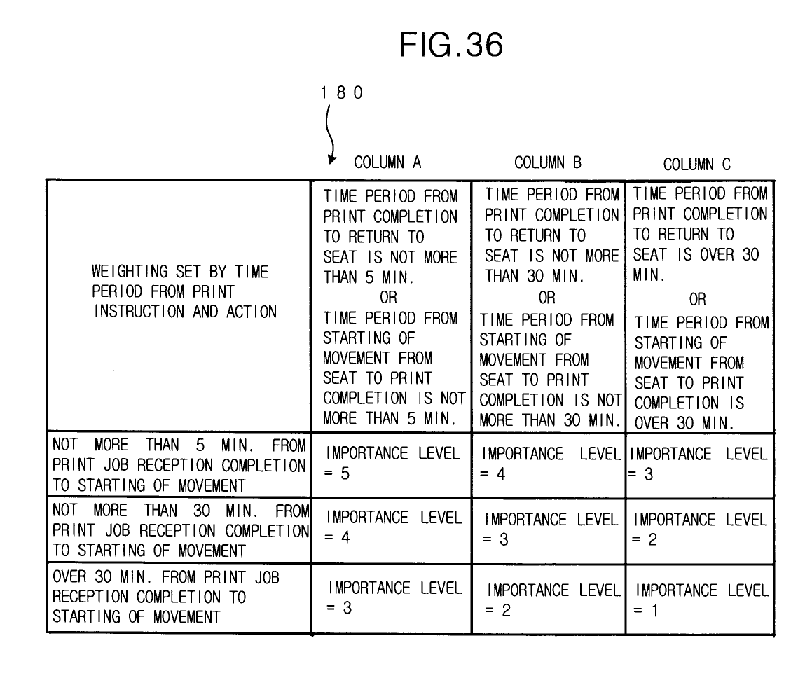

FIG. 36 shows the first judgment condition table 180 in which the judgment conditions for judging the importance of each print job are registered. In the first judgment condition table 180, in case that the time period (4) which elapses from the time and date of the completion of the print to the return to the user's seat is not more than 5 minutes, or that the time period (2) which elapses from the starting of the movement from the user's seat to the completion of the print is not more than 5 minutes (column A), if the time period (3) which elapses from the print job reception completion to the starting of the movement is not more than 5 minutes, the importance level of the job is 5. If the time period (3) is over 5 minutes and not more than 30 minutes, the importance level of the job is 4. If the time period (3) is over 30 minutes, the importance level of the job is 3.

In case that the time period (4) which elapses from the time and date of the completion of the print to the return to the user's seat is over 5 minutes and not more than 30 minutes, or that the time period (2) which elapses from the starting of the movement from the user's seat to the completion of the print is over 5 minutes and not more than 30 minutes (column B), if the time period (3) which elapses from the print job reception completion to the starting of the movement is not more than 5 minutes, the importance level of the job is 4. If the time period (3) is over 5 minutes and not more than 30 minutes, the importance level of the job is 3. If the time period (3) is over 30 minutes, the importance level of the job is 2.

In case that the time period (4) which elapses from the time and date of the completion of the print to the return to the user's seat is over 30 minutes, or that the time period (2) which elapses from the starting of the movement from the user's seat to the completion of the print is over 30 minutes (column C), if the time period (3) which elapses from the print job reception completion to the starting of the movement is not more than 5 minutes, the importance level of the job is 3. If the time period (3) is over 5 minutes and not more than 30 minutes, the importance level of the job is 2. If the time period (3) is over 30 minutes, the importance level of the job is 1.

In FIG. 35A, the CPU 51 of the information collecting terminal 50 aggregates the number of times of executing the print jobs with respect to each user and each importance level of the jobs (Step S806). For example, when the CPU 51 aggregates the number of times of executing the print jobs with respect to the user A and the user B, the CPU 51 calculates the number of times of executing the jobs having the importance level of 5 by the user A, the number of times of executing the jobs having the importance level of 4 by the user A, the number of times of executing the jobs having the importance level of 3 by the user A, the number of times of executing the jobs having the importance level of 2 by the user A, and the number of times of executing the jobs having the importance level of 1 by the user A. Further, the CPU 51 calculates the number of times of executing the jobs having the importance level of 5 by the user B, the number of times of executing the jobs having the importance level of 4 by the user B, the number of times of executing the jobs having the importance level of 3 by the user B, the number of times of executing the jobs having the importance level of 2 by the user B, and the number of times of executing the jobs having the importance level of 1 by the user B.

Further, the CPU 51 aggregates the number of times of executing the Scan To Box jobs (also referred to as “scan job”). That is, the CPU 51 calculates the time period (5) which elapses from the time and date of the reading completion to the time and date of obtaining the file by using the user terminal 30 (the time and date of the transmitting the file) with respect to each job registered in the scan job history table 160 (FIG. 33) (Step S807).

The CPU 51 judges the importance of each scan job in accordance with the above time period (5).

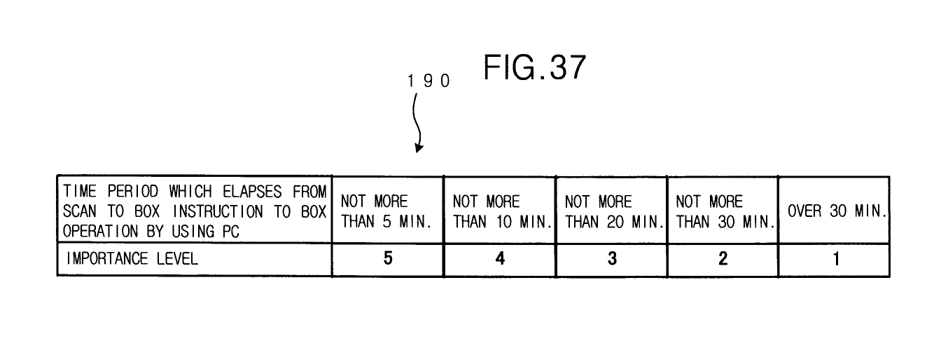

FIG. 37 shows the second judgment condition table 190 in which the judgment conditions for judging the importance of each scan job are registered. For example, in the second judgment condition table 190, if the time period (5) which elapses from the time and date of the reading completion to the time and date of the transmitting the file is not more than 5 minutes, the CPU 51 judges that importance level of the job is 5. If the time period (5) is over 5 minutes and not more than 10 minutes, the CPU 51 judges that importance level of the job is 4. If the time period (5) is over 10 minutes and not more than 20 minutes, the CPU 51 judges that importance level of the job is 3. If the time period (5) is over 20 minutes and not more than 30 minutes, the CPU 51 judges that importance level of the job is 2. If the time period (5) is over 30 minutes, the CPU 51 judges that importance level of the job is 1.

In FIG. 35B, the CPU 51 of the information collecting terminal 50 aggregates the number of times of executing the scan jobs with respect to each user and each importance level of the jobs (Step S809).

Further, the CPU 51 of the information collecting terminal 50 aggregates the number of times of executing the copy jobs which are registered in the copy job history table 170, with respect to each user (Step S810).

Next, the CPU 51 aggregates the number of times of executing the print jobs and the number of times of executing the scan jobs with respect to each user and each importance level, and calculates the importance of each user by further considering the number of times of executing the copy jobs in addition to the above aggregated number of times of executing the print jobs and the above aggregated number of times of executing the scan jobs (Step S811).

In the present embodiment, the CPU 51 carries out the following aggregations with respect to each user. In case of the print jobs, the CPU 51 calculates the value P by multiplying the importance level by the number of times of executing the print jobs with respect to each importance level and by summing the values obtained by the above multiplications for all the importance levels. In case of the scan jobs, the CPU 51 calculates the value S by multiplying the importance level by the number of times of executing the scan jobs with respect to each importance level and by summing the values obtained by the above multiplications for all the importance levels. Then, the CPU 51 calculates the sum of the values P, the value S and the value C which is the number of times of executing the copy jobs as the importance of the user.

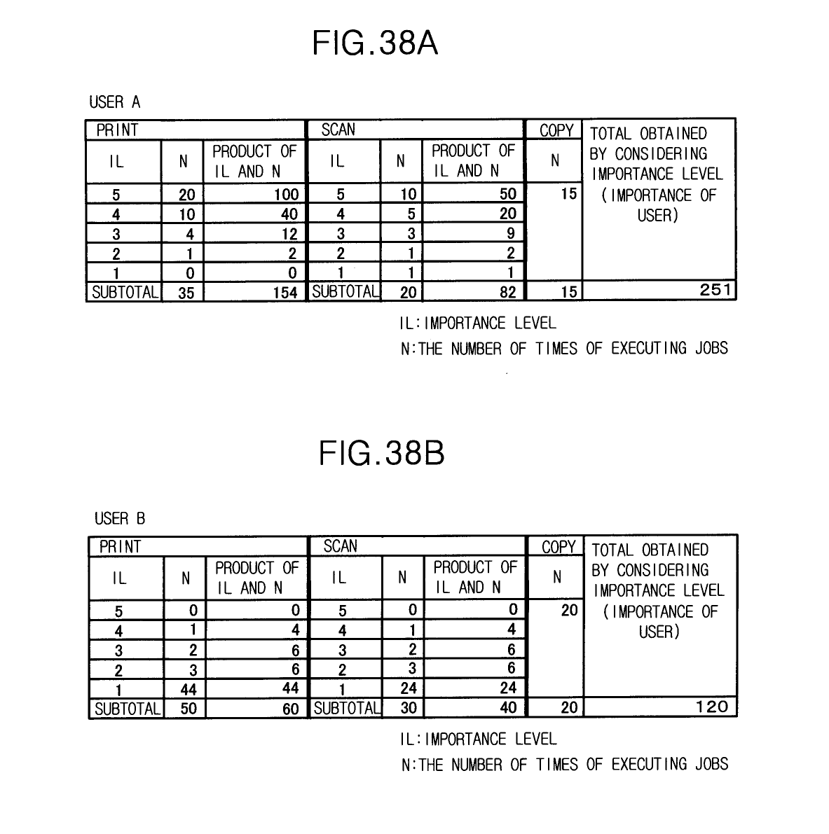

FIG. 38A and FIG. 38B show the examples of the aggregation results relating to the user A and the user B. In FIG. 38A, the aggregation result relating to the user A is shown. In FIG. 38B, the aggregation result relating to the user B is shown. In case of the user A, because the user A instructs the multi-function peripheral 10 to execute the print jobs (print) having the importance level 5 twenty times (5×20=100), to execute the print jobs having the importance level 4 ten times (4×10=40), to execute the print jobs having the importance level 3 four times (3×4=12) and to execute the print jobs having the importance level 2 once (2×1=2) and the user A does not instruct the multi-function peripheral 10 to execute the print jobs having the importance level 1 (1×0=0), the sum of the importance relating to the print jobs is 154.

With respect to the scan jobs, because the user A instructs the multi-function peripheral 10 to execute the scan jobs having the importance level 5 ten times (5×10=50), to execute the scan job having the importance level 4 five times (4×5=20), to execute the scan job having the importance level 3 three times (3×3=9), to execute the scan job having the importance level 2 once (2×1=2), and to execute the scan job having the importance level 1 once (1×1=1), the sum of the importance relating to the scan jobs is 82. Further, because the user A instructs the multi-function peripheral 10 to execute the copy jobs fifteen times, the importance of the user A is 251 (154+82+15). Accordance to FIG. 38B, the importance of the user B is 120.

From the importance of each user, which is calculated as described above, the CPU 51 calculates the importance ratio which indicates the ratio of the importance between the users (Step S812). In the above examples, the importance ratio between the user A and the user B is 251:120.

The CPU 51 of the information collecting terminal 50 calculates the ratio of the distance between each user and the multi-function peripheral 10 from the importance ratio, and proposes the suitable installation place of the multi-function peripheral 10 or evaluates the installation place (Step S813).

For example, the CPU 51 recommends the arrangement of the multi-function peripheral 10, in which the ratio of the distance between each user and the multi-function peripheral 10 is the reciprocal ratio of the importance ratio. In the above case, because the importance ratio between the user A and the user B is 251:120, the CPU 51 recommends the arrangement of the multi-function peripheral 10, in which the ratio of the distance La between the user A's seat and the multi-function peripheral 10 to the distance Lb between the user B's seat and the multi-function peripheral 10 is 120:251. In case that the actual distance between the user A's seat and the multi-function peripheral 10 is denoted by LaR and the actual distance between the user B's seat and the multi-function peripheral 10 is denoted by LbR, the CPU 51 evaluates the current installation place of the multi-function peripheral 10 according to whether the ratio of LaR to LbR approximates 120:251.

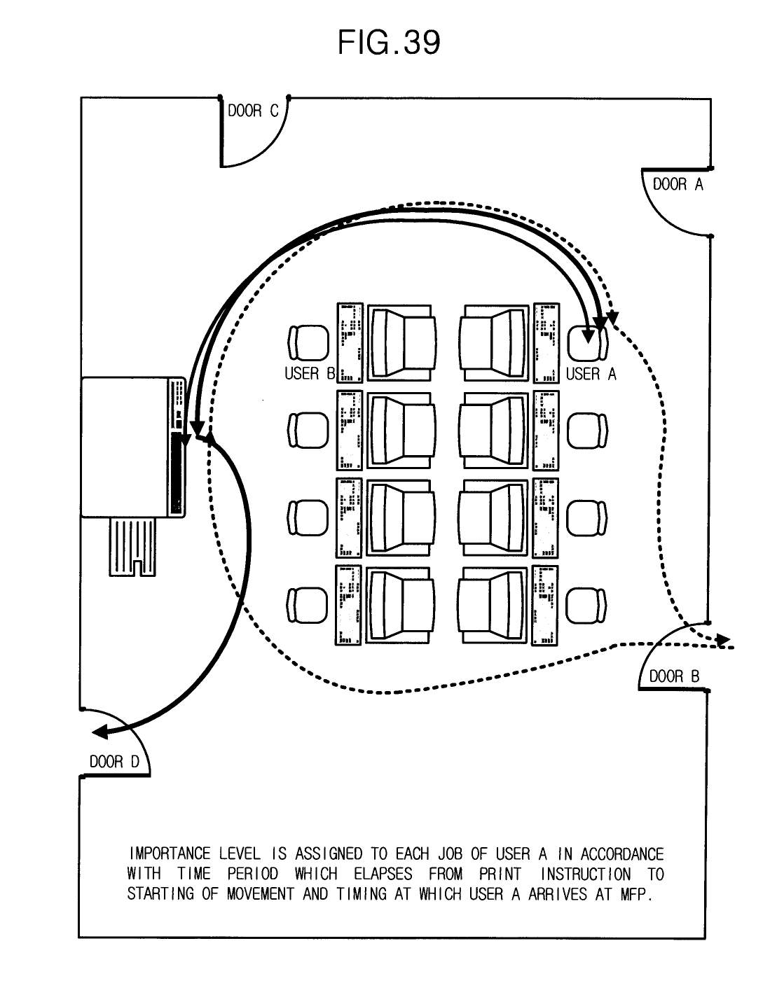

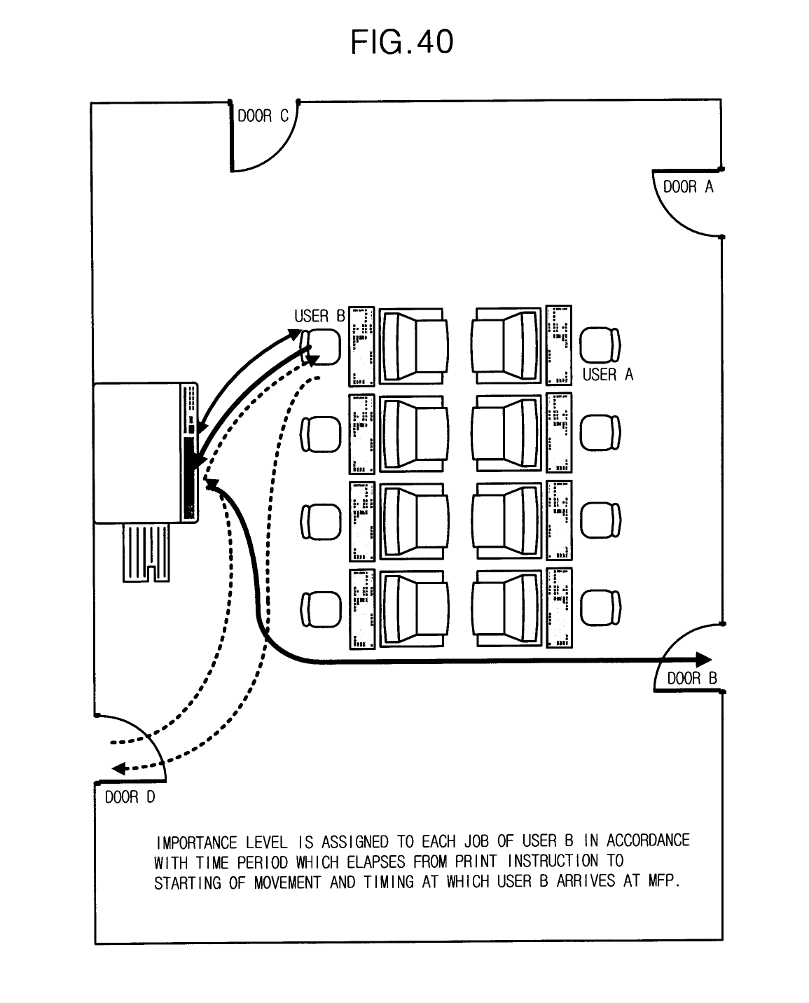

FIG. 39 shows the movement loci of the user A in the respective print jobs so as to overlap them. FIG. 40 shows the movement loci of the user B in the respective print jobs so as to overlap them. The CPU 51 judges the importance of each user from the above job histories.

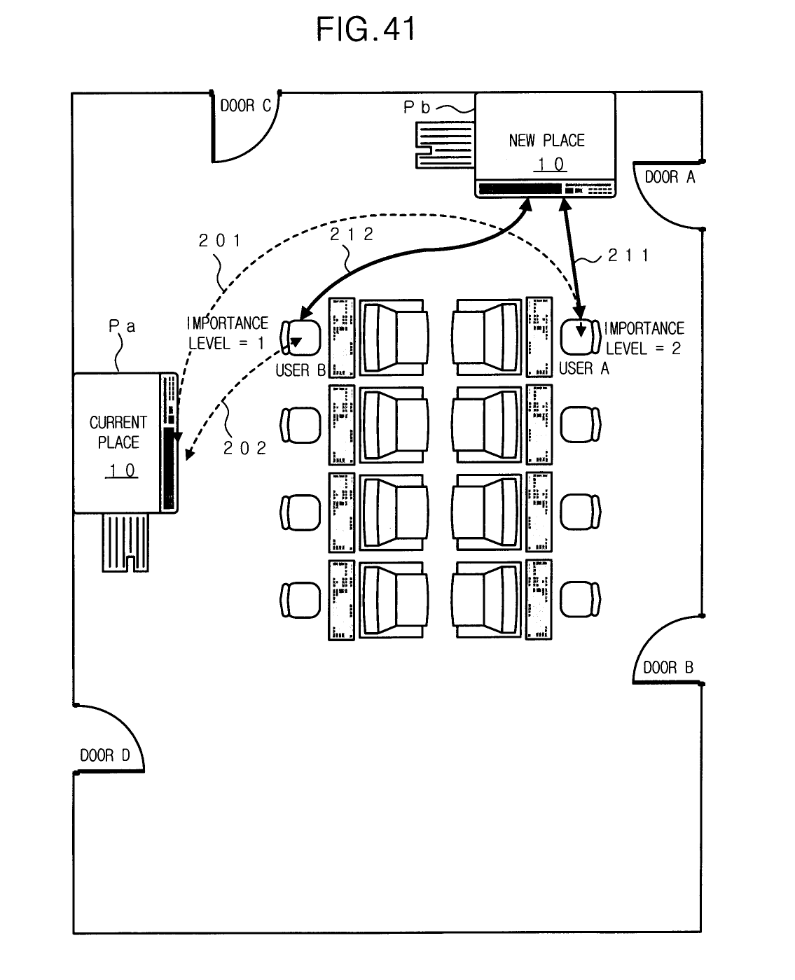

FIG. 41 shows the example case in which the importance of the user A is 2 and the importance of the user B is 1. When the multi-function peripheral 10 is installed in the new place Pb, the ratio of the distance between the user A and the multi-function peripheral 10 to the distance between the user B and the multi-function peripheral 10 is 1:2. Because the above ratio coincides with the reciprocal ratio of the importance ratio between the user A and the user B, the CPU 51 judges that the new installation place Pb is a suitable installation place as compared with the current installation place Pa of the multi-function peripheral 10. In FIG. 41, the route 201 on which the user A moves between the current installation place Pa and the user A's seat, and the route 202 on which the user B moves between the current installation place Pa and the user B's seat, are shown by dashed lines. The route 211 on which user A moves between the new installation place Pb and the user A's seat, and the route 212 on which the user B moves between the new installation place Pb and the user B's seat, are shown by solid lines.

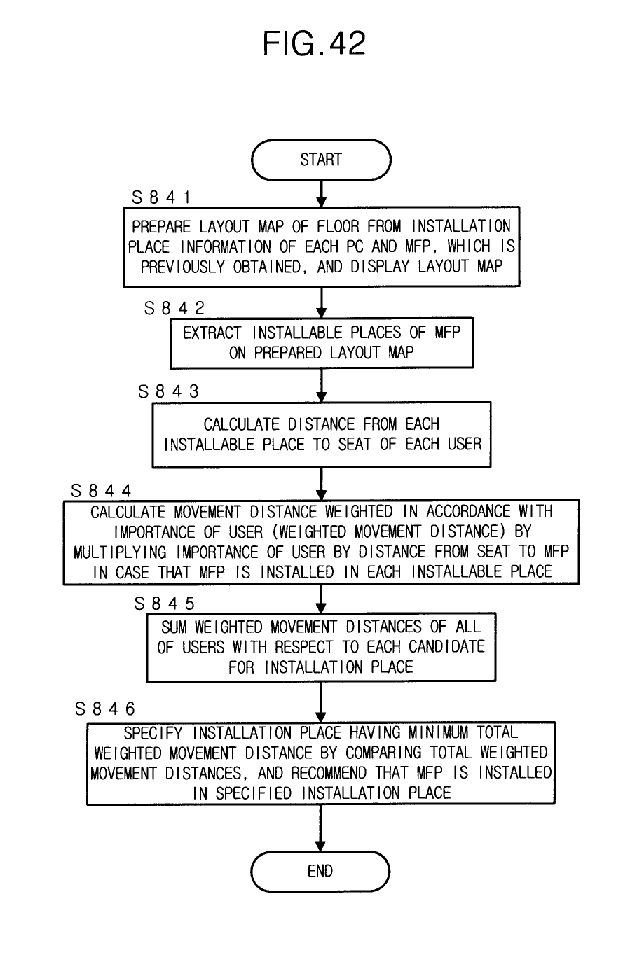

FIG. 42 shows another example of the evaluation process for the installation place of the multi-function peripheral 10. In this example, the information collecting terminal 50 extracts the candidates for the installable place of the multi-function peripheral 10 from the layout map of the floor and judges the most suitable installation place among the evaluated candidates. In detail, the CPU 51 of the information collecting terminal 50 prepares the layout map of the floor from the installation place information of each user terminal 30, that of the multi-function peripheral 10 and the like, which are previously obtained, and instructs the display unit 57 to display the layout map (Step S841).

In the prepared layout map, the CPU 51 extracts the installable places (the candidates for the installation place) of the multi-function peripheral 10 (Step S842). For example, the conditions required to install the multi-function peripheral 10 are previously registered in the hard disk drive 56 of the information collecting terminal 50 and the CPU 51 extracts the places satisfying the conditions as the candidates for the installation place. The conditions for the installation of the multi-function peripheral 10 include the floor space required to install the multi-function peripheral 10, the distance to an electrical outlet, the installation area which is positioned along the wall, the distance to a door and the like.

Next, the CPU 51 calculates the distance to the seat of each user from each candidate for the installation place of the multi-function peripheral 10 (Step S843). Then, the CPU 51 calculates the weighted movement distance of each user in case that the multi-function peripheral 10 is installed in each candidate for the installation place (Step S844). The weighted movement distance is the value obtained by multiplying the importance of the user by the distance between the seat of the user and the multi-function peripheral 10.

Next, the CPU 51 calculates the sum of the weighted movement distances of all of the users (total weighted movement distance) (Step S845). The CPU 51 designates the candidate for the installation place having the minimum total weighted movement distance as the recommended installation place of the multi-function peripheral 10 and instructs the display unit 57 to display the recommended installation place (Step S846).

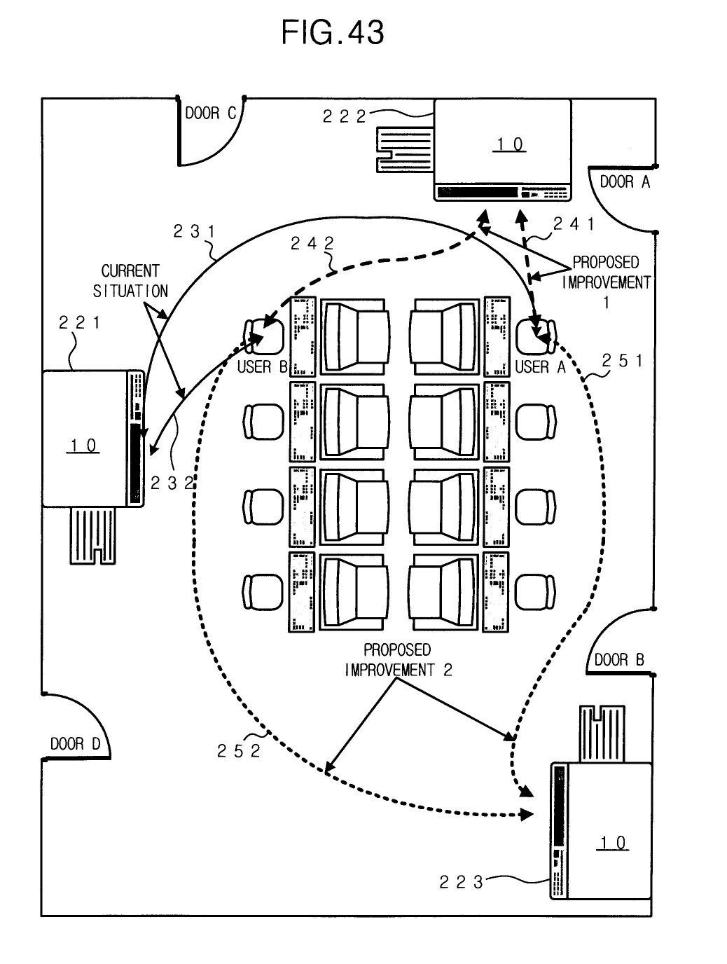

FIG. 43 shows the layout map in case that the current installation place 221 is displayed and the first candidate 222 for the installation place and the second candidate 223 for the installation place are extracted. In FIG. 43, the route 231 on which the user A moves between the current installation place 221 and the user A's seat, the route 232 on which the user B moves between the current installation place 221 and the user B's seat, the route 241 on which the user A moves between the first candidate 222 for the installation place and the user A's seat, the route 242 on which the user B moves between the first candidate 222 for the installation place and the user B's seat, the route 251 on which the user A moves between the second candidate 223 for the installation place and the user A's seat, and route 252 on which the user B moves between the second candidate 223 for the installation place and the user B's seat, are shown.

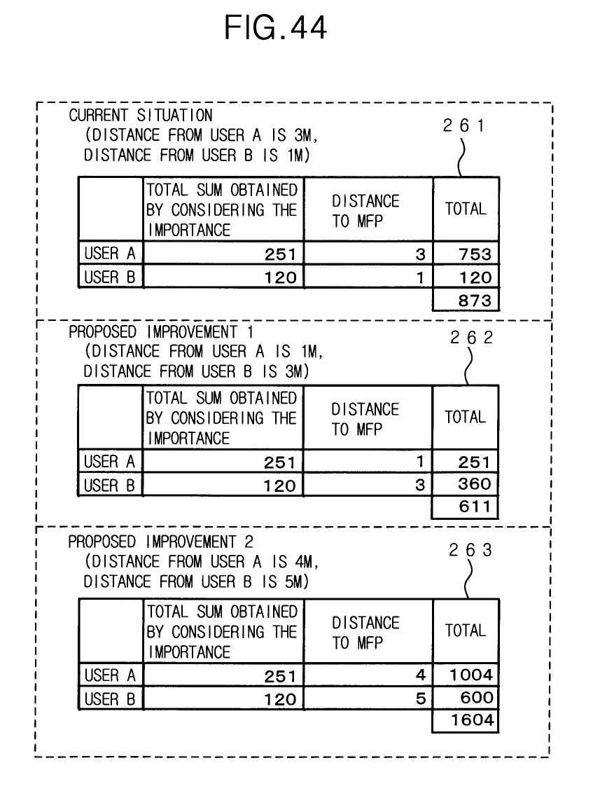

FIG. 44 shows the calculation table 261 of the total weighted movement distance in case of the current installation place 221, the calculation table 262 of the total weighted movement distance in case of the first candidate 222 for the installation place, and the calculation table 263 of the total weighted movement distance in case of the second candidate 223 for the installation place. The information collecting terminal 50 displays these calculation tables for the installation places as the evaluation result on the display unit 57 so as to compare the these calculation tables.

In the calculation tables 261, 262 and 263 of the total weighted movement distances, the value of the total sum obtained by considering the importance is the importance of the user and corresponds to the value calculated in FIG. 38A and FIG. 38B.

As shown in the calculation table 261 of the total weighted movement distance, in case of the current installation place 221, the distance from the user A to the multi-function peripheral 10 is 3 m and the distance from the user B to the multi-function peripheral 10 is 1 m. The weighted movement distance of the user A is 753 which is the produce of the total sum obtained by considering the importance (the importance of the user A) and the distance to the multi-function peripheral 10 (251×3). The weighted movement distance of the user B is 120 (120×1). The total weighted movement distance is 873 which is obtained by summing the weighted movement distances of the user A and the user B.

As shown in the calculation table 262 of the total weighted movement distance, in case of the first candidate 222 for the installation place, the distance from the user A to the multi-function peripheral 10 is 1 m and the distance from the user B to the multi-function peripheral 10 is 3 m. The weighted movement distance of the user A is 251 (251×1). The weighted movement distance of the user B is 360 (120×3). The total weighted movement distance is 611 which is obtained by summing the weighted movement distances of the user A and the user B.

As shown in the calculation table 263 of the total weighted movement distance, in case of the second candidate 223 for the installation place, the distance from the user A to the multi-function peripheral 10 is 4 m and the distance from the user B to the multi-function peripheral 10 is 5 m. The weighted movement distance of the user A is 1004 (251×4). The weighted movement distance of the user B is 600 (120×5). The total weighted movement distance is 1604 which is obtained by summing the weighted movement distances of the user A and the user B.

Therefore, in this case, the first candidate 222 for the installation place, which has the minimum total weighted movement distance, is the recommended installation place. However, the method for evaluating the installation place and the method for displaying the evaluation result are not limited to the above example.

As described above in the present embodiment, the information collecting terminal 50 judges the importance (urgency) of each job which the user inputs to the multi-function peripheral 10 in accordance with the time period which elapses from the input operation of the job to the user's reception of the resultant caused by the job, to aggregate the importance assigned to each job with respect to each user. Then, in accordance with the aggregation result, the information collecting terminal 50 calculates the importance of each user. The information collecting terminal 50 proposes the suitable arrangement of the multi-function peripheral 10 or evaluates the installation place of the multi-function peripheral 10 in accordance with the importance of each user. Therefore, it is possible to propose the arrangement of the multi-function peripheral 10 so as to match the actual usage of the multi-function peripheral 10 by each user by considering the urgency of each job.

As described above, the embodiment is explained by using the drawings. However, in the present invention, the concrete configuration is not limited to the above embodiment. In the present invention, various modifications of the above embodiment or the addition of various functions or the like to the embodiment can be carried out without departing from the gist of the invention.

When the CPU 51 of the information collecting terminal 50 aggregates the importance of the jobs, the time period for aggregating the importance may be optionally set. For example, the time period is set to the past month or the past week, or by determining the starting date and the ending date of the time period.

In this embodiment, the CPU 51 of the information collecting terminal 50 judges the importance of each job in accordance with the time period, such as the period until the starting of the movement or the period for the movement. However, in case that the movement loci are tracked, the importance of each job may be judged in accordance with the movement distance. That is, the CPU 51 checks whether the user moves from the user's seat to the multi-function peripheral 10 on the shortest route or whether the user detours to the multi-function peripheral 10, and can judge that the importance of the job is high as the route approximates the shortest route. Because the user moves to the multi-function peripheral 10 only for the purpose of the job, it is judged that the importance of the job is high. Similarly, in case that the user returns back to the user's seat from the multi-function peripheral 10, the CPU 51 judges that the importance of the job is high as the route of the user approximates the shortest route.

For example, in case that the user authorization is carried out by using the operating panel 25 of the multi-function peripheral 10, the CPU 51 of the information collecting terminal 50 analyzes the movement locus of the authorized user, on which the user moves before the login, and judges whether the route from the user's seat to the multi-function peripheral 10 approximates the shortest route. Further, by analyzing the movement locus of the user, on which the user moves after the completion of the print or the completion of the scanning, the CPU 51 can determine how far the route on which the user returns from the multi-function peripheral 10 to the user's seat, is from the shortest route. The CPU 51 judges the importance of the job in accordance with the above determination. Further, the CPU 51 may judge the importance of the job in accordance with both of the route on which the user moves to the multi-function peripheral 10 and the route on which the user returns back to the user's seat, or in accordance with either of the above two routes.

In the embodiment, with respect to the scan jobs, the CPU 51 of the information collecting terminal 50 judges the importance of the job in accordance with the time period which elapses since the original is read until the user accesses the file of resultant caused by reading the original. However, the standard for judging the importance is not limited to the above time period. For example, by considering various types of standard, such as the time period which elapses since the user carries the original and rises from the user's seat until the user arrives at the multi-function peripheral 10, the route on which the user moves from the user's seat to the multi-function peripheral 10, the time period which elapses since the scanning is completed until the user returns back to the user's seat, the route on which the user moves from the multi-function peripheral 10 to the user's seat, or the like, the CPU 51 may judge the importance (urgency) of each job.

For example, in case of the Scan To Email job, because the file obtained by the scanning is transmitted to the destination, the user does not access the box in the multi-function peripheral 10 from the user terminal 30 in order to obtain the file. Therefore, the CPU 51 of the information collecting terminal 50 cannot judge the importance of each job in accordance with the time period which elapses since the original is read until the user accesses the file of the resultant caused by reading the original. However, the CPU 51 can judge the importance of the scan job in accordance with the movement time or the route from the user's seat to the multi-function peripheral 10, or the movement time or the route from the multi-function peripheral 10 to the user's seat. That is, the CPU 51 can judge that the importance of the scan job is high as the movement time or the movement distance approximates the smallest value.

In case of the copy job, the CPU 51 of the information collecting terminal 50 can judge the importance of the copy job in accordance with the time period which elapses since the user starts the movement until the user arrives at the multi-function peripheral 10 or the route on which the user moves from the user's seat to the multi-function peripheral 10 and/or the time period which elapses since the copy is completed until the user returns back to the user's seat from the multi-function peripheral 10 or the route on which the user moves from the multi-function peripheral 10 to the user's seat. That is, the CPU 51 can judge that the importance of the copy job is high as the movement time or the movement distance approximates the smallest value.

In case the importance of each copy job is calculated, like the case of the print job shown in the embodiment, the CPU 51 of the information collecting terminal 50 may evaluate the installation position in accordance with the importance of each copy job.

The criterion for classifying each job into the importance levels in accordance with the movement time, the route or the like, can be optionally set. Further, the number of the importance levels is not limited to 5 (1 to 5), and can be optionally set.

When the CPU 51 of the information collecting terminal 50 judges the importance of each user by aggregating the importance of each print job, the importance of each scan job and the importance (or the number of times) of each copy job, the CPU 51 may weight the jobs in accordance with the type of jobs. In the embodiment, as shown in FIG. 38A and FIG. 38B, the CPU 51 calculates “the total sum obtained by considering the importance” without weighting the jobs in accordance with the type of jobs. However, the total sum may be calculated by weighting each print job, such as by doubling the importance of each print job. The ratio of the weighting of each job in accordance with the type of jobs can be optionally set or changed by the user.

In the embodiment, the multi-function peripheral 10 is exemplified as the shared device. The shard device may be a device which has at least one function of a print function, a scan function and a copy function and which is shared by a plurality of users. For example, the shared device includes a copying machine, a printer, a scanner and the like.

In the embodiment, the standard for judging the importance of each print job is the time period which elapses from the print instruction to the starting of the movement, the time period which elapses since the user starts the movement until the user arrives at the multi-function peripheral 10, the time period which elapses since the copy is completed until the user returns back to the user's seat, or the like. However, in order to judge the importance of each print job, it is not necessary to use all of the above standards. The importance of each print job can be judged in accordance with one or more optional standards. Further, the importance of each scan job and the importance of each copy job can be also judged in accordance with one or more optional standards.

For example, in case of the print jobs, the CPU 51 of the information collecting terminal 50 can judge the importance of each print job in accordance with one or more standards selected from the time period which elapses since the user provides the print instruction until the user receives the printed document, the time period which elapses since the user receives the printed document until the user returns back to the user's seat, the route on which the user moves from the user's seat to the multi-function peripheral 10 in order to receive the printed document after the user provides the print instruction and the route on which the user moves to the user's seat after the user receives the printed document.

In case of the scan jobs, the CPU 51 of the information collecting terminal 50 judges the importance of each job in accordance with the action of the user, which is involved with the starting operation for starting an original reading job or the action of the user, which is involved with the reception of the resultant caused by the reading job. That is, the CPU 51 can judge the importance of each scan job in accordance with one or more standards selected from the standards, such as the time period or the route to move from the user's seat to the multi-function peripheral 10, the time period or the route to move from the multi-function peripheral 10 to the user's seat, or the time period which elapses since the user returns back to the user's seat until the user accesses the file obtained by the scanning. In case of the copy jobs, the CPU 51 judges the importance of each job in the same way.

In the embodiment, the information collecting terminal 50 has the functions of the layout evaluating apparatus. However, the shared device, such as the multi-function peripheral 10 or the like, may have the functions of the layout evaluating apparatus.

One of the objects of the above embodiment is to provide a layout evaluating apparatus which can evaluate the arrangement of the shared device in accordance with the urgency and/or the importance of each job.

In the above embodiment, the importance (urgency) of each print is judged in accordance with the action of the user, which is involved with the print instruction, for example, the time period which elapses since the user provides the print instruction until the user starts to move to a print device as the shared device, the time period which elapses since the user starts the movement until the user arrives at the shared device, the route on which the user moves from the user's seat to the shared device, the time period which elapses since the user receives the printed document until the user returns back to the user's seat, the route on which the user moves from the shared device to the user's seat, or the like. Then, the importance of each print is aggregated with respect to each user. As the aggregated value becomes large, the user frequently provides the urgent print instruction. Preferably, the shared device is installed near the user having the large aggregated value. Therefore, the installation place of the shared device is evaluated in accordance with the aggregated importance of each print with respect to each user.

In the above embodiment, it is judged that the importance (urgency) of the print is high as the time period which elapses since the user provides the print instruction until the user receives the printed document becomes short or as the time period which elapses since the user receives the printed document until the user returns back to the user's seat becomes short.

In the above embodiment, it is judged that the importance (urgency) of the print is high as the route on which the user moves since the user provides the print instruction until the user receives the printed document becomes short or as the route on which the user moves since the user receives the printed document until the user returns back to the user's seat becomes short.

In the above embodiment, the importance (urgency) of each reading job is judged in accordance with the action of the user carrying out the start operation for starting the reading job to read the original, for example, the time period which elapses since the user carries out the operation for starting the reading until the user accesses the file of the resultant caused by the reading, the movement time period in which the user who carries the original moves from the user's seat to the reading device as the shared device, the route on which the user moves from the user's seat to the shared device, the time period which elapses since the reading of the original is completed until the user returns back to the user's seat, the route on which the user moves from the shared device to the user's seat, or the like. Then, the importance of each reading job is aggregated with respect to each user. As the aggregated value becomes large, the user frequently inputs the urgent reading jobs. Preferably, the shared device is installed near the user having the large aggregated value. Therefore, the installation place of the shared device is evaluated in accordance with the aggregated importance of each reading job with respect to each user.

In the above embodiment, the shared device is a multi-function peripheral having the print function and the original reading function. The installation place of the multi-function peripheral is evaluated by aggregating the importance of each print and the importance of each reading job with respect to each user.

In the above embodiment, it is judged that the importance of the reading job is high as the time period which elapses since the user carries out the starting operation for starting the reading job until the user carries out the operation for a file of the resultant caused by the reading job becomes short.

In the above embodiment, it is judged that the importance of the reading job is high as the time period which elapses since the user carries out the starting operation for starting the reading job until the user returns back to the user's seat becomes short.

In the above embodiment, it is judged that the importance of the reading job is high as the time period which elapses since the user carrying the original starts the movement from the user's seat to the reading device as the shared device until the user carries out the starting operation for starting the reading job at the reading device becomes short.

In the above embodiment, it is judged that the importance of the reading job is high as the route on which the user moves since the user carries out the starting operation for starting the reading job until the user returns back to the user's seat becomes short.

In the above embodiment, it is judged that the importance of the reading job is high as the route on which the user moves since the user carrying the original starts the movement from the user's seat to the reading device as the shared device until the user carries out the starting operation for starting the reading job at the reading device becomes short.

In the above embodiment, in case of the shared device having the copy function, the installation place of the shared device is evaluated by further considering the aggregated number of times of executing the copy job with respect to each user.

In the above embodiment, the aggregated importance of each job with respect to each user has a large value as the user frequently inputs the jobs having the high importance. Therefore, the aggregated importance of each job with respect to each user indicates the importance of each user, that is, whether the user is the important person as the user of the shared device. Therefore, in accordance with the importance of each user, the recommended ratio of the distance between each user and the shared device is calculated.

In the above embodiment, the installation place of the shared device, in which the ratio of the actual distance between each user and the shared device approximates the ratio calculated in accordance with the importance of each user, is determined and displayed.

In the above embodiment, the weighted movement distance of the user is calculated by multiplying the importance of the user by the distance between the user's seat and the shared device. As the variation in the weighted movement distance among the users becomes small, the shared device is installed in the place which is unbiased to all of the users. By displaying weighted movement distances of the users so as to compare them, it is possible to discuss the installation place of the shared device, for example, which seat the shared device is installed near.

In the above embodiment, as the total of the weighted movement distances (total weighted movement distances) of all of the users becomes smaller, the total of the movement burden to all of the users is small. Therefore, the installation place in which the total of the weighted movement distances of all of the users is minimal is displayed as the recommended installation place.

According to the layout evaluating apparatus, because the arrangement of the shared device is evaluated in accordance with the urgency and/or the importance of each job, it is possible to suitably evaluate the arrangement of the shared device in accordance with the actual usage of the shared device by each user.

What is claimed is:

1. A layout evaluating apparatus comprising:
a detecting unit to detect an action of a user who provides a print instruction to a shared device which is shared by a plurality of users and has a print function, the action being involved with the print instruction;
a judging unit to judge importance of a print in the print instruction in accordance with the action of the user, which the detecting unit detects; and
an evaluating unit to aggregate the importance of each print with respect to each user and to evaluate an installation place of the shared device in accordance with the aggregated importance of each print with respect to each user.

2. The layout evaluating apparatus of claim 1, wherein the detecting unit detects at least one of a time period which elapses since the user provides the print instruction until the user receives a printed document and a time period which elapses since the user receives the printed document until the user returns back to a seat of the user, as the action involved with the print instruction, and
the judging unit judges that the importance of the print is high as the detected time period becomes short.

3. The layout evaluating apparatus of claim 1, wherein the detecting unit detects at least one of a route on which the user moves since the user provides the print instruction until the user receives a printed document and a route on which the user moves since the user receives the printed document until the user returns back to a seat of the user, as the action involved with the print instruction, and
the judging unit judges that the importance of the print is high as the detected route approximates a shortest route.

4. A layout evaluating apparatus comprising:
a detecting unit to detect at least one of an action of a user, which is involved with a starting operation for starting a reading job to read an original by using a shared device which is shared by a plurality of users and has an original reading function, and an action of the user, which is involved with a reception of a resultant caused by the reading job;
a judging unit to judging importance of the reading job in accordance with the detected action of the user; and
an evaluating unit to aggregate the importance of each reading job with respect to each user and to evaluate an installation place of the shared device in accordance with the aggregated importance of each reading job with respect to each user.

5. The layout evaluating apparatus of claim 1, wherein the shared device further has an original reading function for reading an original,
the detecting unit detects at least one of an action of the user, which is involved with a starting operation for starting a reading job to read an original by using the shared device, and an action of the user, which is involved with a reception of a resultant caused by the reading job,
the judging unit judges importance of the reading job in accordance with the detected action of the user, and
the evaluating unit aggregates the importance of each reading job with respect to each user and evaluates the installation place of the shared device in accordance with the aggregated importance of each reading job with respect to each user and the aggregated importance of each print with respect to each user.

6. The layout evaluating apparatus of claim 4, wherein the detecting unit detects a time period which elapses since the user carries out the starting operation until the user carries out an operation for a file of the resultant caused by the reading job, as the action involved with the reception of the resultant, and
the judging unit judges that the importance of the reading job is high as the detected time period becomes short.

7. The layout evaluating apparatus of claim 5, wherein the detecting unit detects a time period which elapses since the user carries out the starting operation until the user carries out an operation for a file of the resultant caused by the reading job, as the action involved with the reception of the resultant, and
the judging unit judges that the importance of the reading job is high as the detected time period becomes short.

8. The layout evaluating apparatus of claim 4, wherein the detecting unit detects a time period which elapses since the user carries out the starting operation until the user returns back to a seat of the user, as the action involved with the reception of the resultant, and
the judging unit judges that the importance of the reading job is high as the detected time period becomes short.

9. The layout evaluating apparatus of claim 5, wherein the detecting unit detects a time period which elapses since the user carries out the starting operation until the user returns back to a seat of the user, as the action involved with the reception of the resultant, and
the judging unit judges that the importance of the reading job is high as the detected time period becomes short.

10. The layout evaluating apparatus of claim 4, wherein the detecting unit detects a time period which elapses since the user starts a movement from a seat of the user until the user carries out the starting operation, as the action involved with the starting operation, and
the judging unit judges that the importance of the reading job is high as the detected time period becomes short.

11. The layout evaluating apparatus of claim 5, wherein the detecting unit detects a time period which elapses since the user starts a movement from a seat of the user until the user carries out the starting operation, as the action involved with the starting operation, and
the judging unit judges that the importance of the reading job is high as the detected time period becomes short.

12. The layout evaluating apparatus of claim 4, wherein the detecting unit detects a route on which the user moves since the user carries out the starting operation until the user returns back to a seat of the user, as the action involved with the reception of the resultant, and
the judging unit judges that the importance of the reading job is high as the detected route becomes short.

13. The layout evaluating apparatus of claim 5, wherein the detecting unit detects a route on which the user moves since the user carries out the starting operation until the user returns back to a seat of the user, as the action involved with the reception of the resultant, and
the judging unit judges that the importance of the reading job is high as the detected route becomes short.

14. The layout evaluating apparatus of claim 4, wherein the detecting unit detects a route on which the user moves since the user rises from a seat of the user until the user carries out the starting operation, as the action involved with the starting operation, and
the judging unit judges that the importance of the reading job is high as the detected route becomes short.

15. The layout evaluating apparatus of claim 5, wherein the detecting unit detects a route on which the user moves since the user rises from a seat of the user until the user carries out the starting operation, as the action involved with the starting operation, and
the judging unit judges that the importance of the reading job is high as the detected route becomes short.

16. The layout evaluating apparatus of claim 1, wherein the shared device further has a copy function for copying an original,
the evaluating unit aggregates the number of times of executing a copy job with respect to each user, and evaluates the installation place of the shared device by further considering the aggregated number of times of executing the copy job with respect to each user.

17. The layout evaluating apparatus of claim 4, wherein the shared device further has a copy function for copying the original,
the evaluating unit aggregates the number of times of executing a copy job with respect to each user, and evaluates the installation place of the shared device by further considering the aggregated number of times of executing the copy job with respect to each user.

18. The layout evaluating apparatus of claim 1, wherein the evaluating unit judges importance of each user in accordance with the aggregated importance of each print with respect to each user, and calculates a recommended ratio of a distance between each user and the shared device in accordance with the judged importance of each user.

19. The layout evaluating apparatus of claim 4, wherein the evaluating unit judges importance of each user in accordance with the aggregated importance of each reading job with respect to each user, and calculates a recommended ratio of a distance between each user and the shared device in accordance with the judged importance of each user.

20. The layout evaluating apparatus of claim 18, further comprising:
an installation place determining unit to determine the installation place of the shared device in accordance with the recommended ratio; and
a display unit to display the determined installation place of the shared device.

21. The layout evaluating apparatus of claim 19, further comprising:
an installation place determining unit to determine the installation place of the shared device in accordance with the recommended ratio; and
a display unit to display the determined installation place of the shared device.

22. The layout evaluating apparatus of claim 18, wherein the evaluating unit calculates a weighted movement distance by multiplying the importance of each user by the distance between each user and the shared device, with respect to each user, and
the display unit displays the weighted movement distances of the plurality of users so as to compare the weighted movement distances.

23. The layout evaluating apparatus of claim 19, wherein the evaluating unit calculates a weighted movement distance by multiplying the importance of each user by the distance between each user and the shared device, with respect to each user, and
the display unit displays the weighted movement distances of the plurality of users so as to compare the weighted movement distances.

24. The layout evaluating apparatus of claim 22, wherein the display unit displays a recommended installation place of the shared device, in which a total of the weighted movement distances of the plurality of users is the smallest among a plurality of candidates for the recommended installation place.

25. The layout evaluating apparatus of claim 23, wherein the display unit displays a recommended installation place of the shared device, in which a total of the weighted movement distances of the plurality of users is the smallest among a plurality of candidates for the recommended installation place.
